(19) United States
(12) Patent Application Publication
(10) Pub. No.: US 2026/0058190 A1
(43) Pub. Date: Feb. 26, 2026

(54) High Voltage Battery Cell, Module or Pack Having a Rolled Structure and Production Method

(71) Applicant: Honeycomb Battery Company, Dayton, OH (US)

(72) Inventors: Hao-Hsun Chang, Centerville, OH (US); Song-Hai Chai, Dayton, OH (US); Bor Z. Jang, Centerville, OH (US)

(73) Assignee: Honeycomb Battery Company, Dayton, OH (US)

(21) Appl. No.: 18/809,962

(22) Filed: Aug. 20, 2024

(51) Int. Cl. H01M 10/0562; H01M 4/02; H01M 4/525; H01M 4/58; H01M 4/60; H01M 4/62; H01M 10/0525; H01M 10/054; H01M 10/0565; H01M 10/0587

(52) U.S. Cl. CPC H01M 10/0562; H01M 4/525; H01M 4/5825; H01M 4/60; H01M 10/0525; H01M 10/054; H01M 10/0565; H01M 10/0587; H01M 2004/027; H01M 2004/028; H01M 4/623; H01M 4/625; H01M 2300/0077; H01M 2300/008; H01M 2300/0082

(57) ABSTRACT

A high-voltage alkali battery, comprising a plurality of unit cells each comprising: (a) a cathode comprising (i) a cathode current collector; and (ii) a cathode active layer bonded to a first portion, but not a second portion, of the current collector, wherein the cathode active layer comprises a mixture of a cathode active material, a binder, a conducting additive, and a non-flowable electrolyte; (b) an anode; and (c) a separator layer, wherein the cathode, separator, and anode layer are laminated and wound into a unit cell roll with the cathode end having the second portion being protruded out and the anode end having the second portion being protruded out; wherein the unit cells are internally connected in such a manner that the second portion of the cathode of a first unit cell roll is in electronic contact with the second portion of the anode of a second unit cell roll.

### FIELD

The present invention relates to the field of rechargeable lithium batteries (lithium-ion and lithium metal batteries), sodium batteries (sodium-ion and sodium metal batteries), and potassium batteries (potassium-ion and potassium metal batteries) and, in particular, to high-voltage alkali batteries having multiple rolled unit cells internally connected in series and, optionally, also in parallel. The batteries deliver both high energy densities and high power densities.

### BACKGROUND

Historically, today's most favorite rechargeable energy storage devices—lithium-ion batteries—actually evolved from rechargeable “lithium metal batteries” using lithium (Li) metal or Li alloy as the anode and a Li intercalation compound as the cathode. Li metal is an ideal anode material due to its light weight (the lightest metal), high electronegativity (−3.04 V vs. the standard hydrogen electrode), and high theoretical capacity (3,860 mAh/g). Based on these outstanding properties, lithium metal batteries were proposed 40 years ago as an ideal system for high energy-density applications. During the mid-1980s, several prototypes of rechargeable Li metal batteries were developed. A notable example was a battery composed of a Li metal anode and a molybdenum sulfide cathode. This and several other batteries were abandoned due to a series of safety problems caused by sharply uneven Li growth (formation of Li dendrites) as the metal was re-plated during each subsequent recharge cycle. As the number of cycles increases, these dendritic or tree-like Li structures could eventually traverse the separator to reach the cathode, causing internal short-circuiting.

To overcome these safety issues, several alternative approaches were proposed in which either the electrolyte or the anode was modified. One approach involved replacing Li metal by graphite (another Li insertion material) as the anode. The operation of such a battery involves shuttling Li ions between two Li insertion compounds, hence the name “Li-ion battery.” Presumably because of the presence of Li in its ionic rather than metallic state, Li-ion batteries are inherently safer than Li-metal batteries.

Lithium ion battery is a prime candidate energy storage device for electric vehicle (EV), renewable energy storage, and smart grid applications. The past two decades have witnessed a continuous improvement in Li-ion batteries in terms of energy density, rate capability, and safety, and somehow the significantly higher energy density Li metal batteries have been largely overlooked. However, the use of graphite-based anodes in Li-ion batteries has several significant drawbacks: low specific capacity (theoretical capacity of 372 mAh/g as opposed to 3,860 mAh/g for Li metal), long Li intercalation time (e.g. low solid-state diffusion coefficients of Li in and out of graphite and inorganic oxide particles) requiring long recharge times (e.g. 7 hours for electric vehicle batteries), inability to deliver high pulse power (power density <<1 kW/kg), and necessity to use pre-lithiated cathodes (e.g. lithium cobalt oxide), thereby limiting the choice of available cathode materials. Further, these commonly used cathodes have a relatively low specific capacity (typically <200 mAh/g). These factors have contributed to the two major shortcomings of today's Li-ion batteries—low gravimetric and volumetric energy densities (typically 150-220 Wh/kg and 450-600 Wh/L) and low power densities (typically <0.5 kW/kg and <1.0 kW/L), all based on the total battery cell weight or volume.

The emerging EV and renewable energy industries demand the availability of rechargeable batteries with a significantly higher gravimetric energy density (e.g. demanding >300 Wh/kg and, preferably, >400 Wh/kg) and higher power density (shorter recharge times) than what the current Li ion battery technology can provide. Furthermore, the microelectronics industry is in need of a battery having a significantly larger volumetric energy density (>750 Wh/L, preferably >850 Wh/L) since consumers demand to have smaller-volume and more compact portable devices (e.g. smart phones and tablets) that store more energy. These requirements have triggered considerable research efforts on the development of electrode materials with a higher specific capacity, excellent rate capability, and good cycle stability for lithium ion batteries.

Several elements from Group III, IV, and V in the periodic table can form alloys with Li at certain desired voltages. Therefore, various anode materials based on such elements and some metal oxides have been proposed for lithium ion batteries. Among these, silicon has been recognized as one of the next-generation anode materials for high-energy lithium ion batteries since it has a nearly 10 times higher theoretical gravimetric capacity than graphite 3,590 mAh/g based on Li_{3.75}Si vs. 372 mAh/g for LiC₆) and ˜3 times larger volumetric capacities. However, the dramatic volume changes (up to 380%) of Si during lithium ion alloying and de-alloying (cell charge and discharge) often led to severe and rapid battery performance deterioration. The performance fade is mainly due to the volume change-induced pulverization of Si and the inability of the binder/conductive additive to maintain the electrical contact between the pulverized Si particles and the current collector. In addition, the intrinsic low electric conductivity of silicon is another challenge that needs to be addressed.

Although several high-capacity anode active materials have been found (e.g., Si), there has been no corresponding high-capacity cathode material available. Current cathode active materials commonly used in Li-ion batteries have the following serious drawbacks:
(1) The practical capacity achievable with current cathode materials (e.g. lithium iron phosphate and lithium transition metal oxides) has been limited to the range of 150-250 mAh/g and, in most cases, less than 200 mAh/g.
(2) The insertion and extraction of lithium in and out of these commonly used cathodes rely upon extremely slow solid-state diffusion of Li in solid particles having very low diffusion coefficients (typically 10⁻⁸ to 10⁻¹⁴ cm²/s), leading to a very low power density (another long-standing problem of today's lithium-ion batteries).
(3) The current cathode materials are electrically and thermally insulating, not capable of effectively and efficiently transporting electrons and heat. The low electrical conductivity means high internal resistance and the necessity to add a large amount of conductive additives, effectively reducing the proportion of electrochemically active material in the cathode that already has a low capacity. The low thermal conductivity also implies a higher tendency to undergo thermal runaway, a major safety issue in lithium battery industry.

As a totally distinct class of energy storage device, sodium batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost.

There are at least two types of batteries that operate on bouncing sodium ions (Na+) back and forth between an anode and a cathode: the sodium metal battery having Na metal or alloy as the anode active material and the sodium-ion battery having a Na intercalation compound as the anode active material. Sodium ion batteries using a hard carbon-based anode active material (a Na intercalation compound) and a sodium transition metal phosphate as a cathode also have been proposed.

However, these sodium-based devices exhibit even lower specific energies and rate capabilities than Li-ion batteries. The anode active materials for Na intercalation and the cathode active materials for Na intercalation have lower Na storage capacities as compared with their Li storage capacities. For instance, hard carbon particles are capable of storing Li ions up to 300-360 mAh/g, but the same materials can store Na ions up to 150-250 mAh/g and less than 100 mAh/g for K ion storage.

Instead of hard carbon or other carbonaceous intercalation compound, sodium metal may be used as the anode active material in a sodium metal cell. However, the use of metallic sodium as the anode active material is normally considered undesirable and dangerous due to the dendrite formation, interface aging, and electrolyte incompatibility problems.

There are strong needs to have higher energy density batteries (e.g., using Li or Na metal as an anode active material) that are safe and resistant to dendrite formation and penetration. Further, with the growing demand for more compact and portable energy storage systems, there is keen interest to increase the utilization of the volume of the batteries in a battery module or pack. Novel electrode materials and battery cell/module/pack configuration designs that enable high energy densities and high power densities at the module or pack level are highly sought after for electric vehicles, power tool, portable devices, and energy storage systems.

### SUMMARY

The present disclosure provides a high-voltage alkali battery wherein the alkali refers to a metal selected from Li, Na, K, or a combination thereof. In particular, the battery can be a lithium battery (a Li-ion battery or any Li metal battery having lithium metal as a primary anode active material, such as Li-NCM, Li—Se, Li—S, and Li-air), sodium battery (a Na-ion battery or any Na metal battery having sodium metal as a primary anode active material, such as Na-Prussian blue, Na—Se, Na—S, and Na-air), or potassium battery (a K-ion battery or any K metal battery having potassium metal as a primary anode active material, such as K-layered metal oxide, K—Se, K—S, and K-air). The battery module can be of any shape, but preferably cylindrical, rectangular, or cuboidal.

The disclosure provides a high-voltage alkali battery, comprising a plurality of unit cells internally connected in series to form a module or pack, wherein each unit cell comprises:
(A)a cathode comprising (i) a cathode current collector comprising a conductive material layer or foil having two opposite primary surfaces, herein referred to as a first and a second primary surface, wherein each primary surface has a first portion (intended to be coated with a cathode active layer) and a second portion (intended to be exposed and free from any active material layer and to be bonded to a corresponding second portion of an anode from a neighboring unit cell); and (ii) a first cathode active layer bonded to the first portion, but substantially not the second portion, of the first primary surface and, optionally, a second cathode active layer bonded to the first portion, but substantially not the second portion, of the second primary surface of the cathode current collector, wherein the first or the second cathode active layer comprises a mixture of a cathode active material, an optional resin binder, an electron-conducting additive, and an optional but desirable first electrolyte;
(B) an anode comprising (i) an anode current collector comprising a conductive material layer or foil having two opposite primary surfaces (a first and a second primary surface), wherein each primary surface has a first portion and a second portion; and (ii) a first anode active layer bonded to the first portion, but substantially not the second portion, of the first primary surface and, optionally, a second anode active layer bonded to the first portion, but substantially not the second portion, of the second primary surface of the anode current collector, wherein the first or the second anode active layer comprises (ii-a) a mixture of an anode active material, an optional binder, an optional electron-conducting additive, and an optional second electrolyte or (ii-b) a layer of alkali metal or alkali metal alloy having higher than 60% by weight of an alkali metal selected from lithium (Li), sodium (Na), potassium (K) or a combination thereof; and
(C) a separator layer, in a form of an ion-permeable material layer or a solid-state electrolyte layer, which is disposed between the anode and the cathode and electrically separating or isolating the anode from the cathode; wherein,
the cathode, the separator, and the anode layer are laminated and wound around an axis into a roll of a unit cell having a roll height (defined to be the width between the cathode end and the anode end of the roll), wherein the cathode end has the second portion of the cathode current collector being protruded or extended out beyond the roll height (and folded or bended to form a positive terminal “tab”, as illustrated in FIG. 2(A)) and not touching the anode current collector and wherein the anode end has the second portion of the anode current collector being protruded or extended out beyond the roll height (and folded or bended to form a negative terminal “tab”) and not touching the cathode current collector;
wherein,
the plurality of the unit cells are internally stacked and connected in such a manner that the protruded or extended out second portion (positive “tab”) of the cathode current collector of a first unit cell roll is in electronic contact with (e.g., welded, soldered, or bonded with) the protruded or extended out second portion (negative “tab”) of the anode current collector of a second, neighboring unit cell roll (as illustrated in FIG. 2(B)), and wherein the first electrolyte and the second electrolyte are the same as or different from each other and all having an ion conductivity no less than 10⁻⁷ S/cm (preferably from 10⁻⁶ S/cm to 5×10⁻² S/cm) and the electrolytes are not flowable wherein the electrolyte in a unit cell is not capable of flowing to and does not flow to a neighboring unit cell.

Preferably, the first or the second electrolyte is selected from a flexible electrolyte that does not flow easily (will not flow from one unit cell to another). Such an electrolyte may be selected from a solid polymer electrolyte, inorganic electrolyte, polymer/inorganic composite electrolyte, a quasi-solid electrolyte having an alkali salt concentration no less than 2.5 M in an organic or ionic liquid solvent, or a semi-solid electrolyte having a liquid content less than 30% by weight of the total electrolyte weight. Being flexible is essential to winding the laminate around an axis to form a roll. These electrolytes also impart flame/fire resistance to the batteries and provide resistance to dendrite formation in alkali metal batteries.

Typically, a traditional lithium-ion cell provides an output voltage of from 3.2 volts (graphite anode and lithium iron phosphate, LFP, cathode) to 3.7 volts (graphite anode and NCM cathode). Now, with two unit cells internally connected in series inside a cylindrical can, the output voltage from the can (a module of two unit cells) is 6.4 volts and 7.4 volts, respectively and yet there is only one protective housing (one cylindrical stainless steel can, for instance) and no external connecting wires. The output voltage of a module of n unit cells will be from 3.2n to 3.7n volts.

In some embodiments, the battery further meets one or more of the following conditions: (a) the cathode comprises from 60% to 98% by weight of a cathode active material, from 1% to 15% of an electron-conducting additive, and/or from 1% to 15% of the first electrolyte selected from a solid-state inorganic, polymeric, or inorganic/polymer composite electrolyte; (b) the anode comprises from 60% to 98% by weight of an anode active material, and (c) the anode comprises from 1% to 15% of the second electrolyte selected from a solid-state inorganic, polymeric, or an inorganic/polymer composite electrolyte.

The first and/or the second electrolyte may be selected from a quasi-solid electrolyte (defined as an electrolyte having an alkali salt concentration higher than 2.5 M in an organic or ionic liquid solvent), a solid polymer electrolyte, a polymer gel electrolyte having a liquid component less than 30% by weight (preferably less than 20%, more preferably less than 10%, and most preferably less than 5%) dispersed in a polymer, an inorganic solid electrolyte, or a polymer/inorganic composite electrolyte.

Preferably, the electrolytes have an ion conductivity greater than 106 S/cm (more preferably greater than 10⁻⁴ S/cm, and most preferably greater than 1026 S/cm) and comprise a quasi-solid electrolyte (comprising an ionic liquid electrolyte or an organic liquid electrolyte containing >2.5M of an alkali metal salt and/or a flame retardant additive dispersed therein), a polymer gel electrolyte, a polymer electrolyte impregnated with 0.1% to 20% by weight of a liquid electrolyte, or a polymer/inorganic composite electrolyte. The flame retardant additive may be selected from a halogenated flame retardant, phosphorus-based flame retardant, melamine flame retardant, metal hydroxide flarne retardant, silicon-based flame retardant, phosphate flame retardant, biomolecular flame retardant, or a combination thereof.

The conductive material layer as a current collector may be selected from a metal foil, a layer of an electrically conductive polymer, a layer of carbon particles, graphite particles, carbon nanotubes, or graphene sheets in a non-woven mat form, fabric form, or dispersed in or bonded by a polymer matrix, or a combination thereof.

The first electrolyte and/or the second electrolyte may comprise a polymer electrolyte selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

The polymer electrolyte preferably comprises from 0.1% to 50% by weight of a lithium salt, a sodium salt, a potassium salt, or a combination thereof. The first electrolyte and/or the second electrolyte may comprise an inorganic electrolyte selected from β-alumina electrolyte, NASICON electrolyte, sulfide-based electrolyte, halide-based electrolyte, complex hydride electrolyte, oxide-type electrolyte, borate-type electrolyte, phosphate-type electrolyte, lithium phosphorus oxynitride (LiPON), garnet-type, lithium superionic conductor (LISICON) type, or a combination thereof.

In the alkali battery module or pack, preferably the separator comprises a solid-state electrolyte, having an alkali metal ion conductivity greater than 106 S/cm (more preferably greater than 10⁻³ S/cm) when measured at room temperature and being selected from a polymer electrolyte, an inorganic electrolyte, or a polymer/inorganic electrolyte.

The alkali battery may be a lithium-ion battery, a lithium metal battery, a sodium-ion battery, a sodium metal battery, a potassium-ion battery, or a potassium metal battery, wherein the lithium metal battery is a battery that comprises lithium metal as an anode active material (e.g., lithium-sulfur, lithium-selenium, and lithium-air battery), the sodium metal battery is a battery that comprises sodium metal as an anode active material (e.g., sodium-sulfur, sodium-selenium, and sodium-air battery), and the potassium metal battery is a battery that comprises potassium metal as an anode active material (e.g., potassium-sulfur, potassium-selenium, and potassium-air battery).

In some embodiments, the high-voltage alkali battery pack comprises multiple high-voltage alkali battery modules (as herein disclosed), which are internally connected in parallel to form a battery pack and the battery pack is housed in a protective casing (inter-module connections are implemented inside the protective housing). This is in sharp contrast to the conventional module or pack wherein individual cells are each housed in a protective casing (e.g., a cylindrical stainless steel tube). These housed cells are then connected externally using connecting wires and tabs that are heavy and bulky, and add additional electrical resistance to the module or pack.

In certain embodiments, the first and/or second electrolyte contains an alkali metal salt (lithium salt, sodium salt, or potassium salt) dissolved in a liquid solvent and/or a polymer and wherein the liquid solvent is water, an organic solvent, an ionic liquid, or a mixture of an organic solvent and an ionic liquid. The concentration of the alkali metal salt in a liquid solvent (without the presence of a polymer dissolved therein) should preferably be higher than 2.5M and more preferably be higher than 3.5M, so that the liquid solvent would not flow (would behave like a solid).

In certain embodiments, the first, second, third, and/or fourth electrolyte contains a solid state electrolyte, quasi-solid electrolyte, or polymer electrolyte (containing an alkali metal salt and/or a liquid solvent dispersed or trapped therein) having a lithium-ion or sodium-ion conductivity from 10⁻⁸ S/cm to 10⁻² S/cm, preferably greater than 10⁻⁵S/cm, and more preferably greater than 10⁻³S/cm.

In some embodiments wherein the alkali battery is a lithium-ion battery, the anode active material may be selected from the group consisting of: (a) Particles of natural graphite, artificial graphite, meso-carbon microbeads (MCMB), carbon (e.g. soft carbon or hard carbon), needle coke, carbon fiber, carbon nano-tube, and carbon nano-fiber; (b) Silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd); (c) Alloys or intermetallic compounds of Si, Ge, Sn, Pb, Sb, Bi, Zn, Al, or Cd with other elements, wherein said alloys or compounds are stoichiometric or non-stoichiometric; (d) Oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites; (e) Pre-lithiated versions thereof; and (f) Pre-lithiated graphene sheets; and combinations thereof.

There is no restriction on the types of anode active materials or cathode active materials that can be used in practicing the instant invention. However, preferably, the anode active material absorbs lithium ions at an electrochemical potential of less than 1.0 volt (preferably less than 0.7 volts and more preferably less than 0.2 volts) above the Li/Li+(i.e. relative to Li →Li⁺+e⁻ as the standard potential) when the battery is charged. The anode active material for Na-ion or K-ion battery can be similarly chosen.

In a preferred embodiment, the anode active material is a pre-sodiated or pre-potassiated version of graphene sheets selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

The starting graphitic material for producing any one of the above graphene materials may be selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof. Graphene materials are also a good conductive additive for both the anode and cathode active materials of an alkali metal battery.

In some embodiments, the alkali battery is a sodium-ion battery and the anode active material contains an alkali intercalation compound selected from petroleum coke, carbon black, amorphous carbon, activated carbon, hard carbon, soft carbon, templated carbon, hollow carbon nanowires, hollow carbon sphere, titanates, NaTi₂(PO₄)₃, Na₂Ti₃O₇, Na₂CsH₄O₄, Na₂TP, NaxTiO₂ (x=0.2 to 1.0), Na₂CsH₄O₄, carboxylate based materials, CsH₄Na₂O₄, C₈H₆O₄, C₈H₅NaO₄, C₈Na₂F₄O₄,C₁₀H₂Na₄O₈, C₁₄H₄O₆, C₁₄H₄Na₄O₈, or a combination thereof.

In some embodiments, the alkali battery is a sodium-ion battery or potassium-ion battery and the anode active material contains an alkali intercalation compound selected from the following groups of materials: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; and (e) Graphene sheets pre-loaded with sodium ions or potassium ions.

In some embodiments, the cathode active material contains a lithium intercalation compound or lithium absorbing compound selected from the group consisting of lithium cobalt oxide, doped lithium cobalt oxide, lithium nickel oxide, doped lithium nickel oxide, lithium manganese oxide, doped lithium manganese oxide, lithium vanadium oxide, doped lithium vanadium oxide, lithium mixed-metal oxides, lithium iron phosphate, lithium vanadium phosphate, lithium manganese phosphate, lithium mixed-metal phosphates, metal sulfides, lithium polysulfide, sulfur, metal selenides, lithium polyselenides, selenium, and combinations thereof.

In the alkali battery, the cathode active material may be selected from a Na-based metal layered oxide, a K-based metal layered oxide, a polyanionic compound, a mixed polyanionic compound, a sulfate, a pyrophosphate, a Prussian Blue analog, a ferrocyanide, an organic compound, or a combination thereof.

In some embodiments, the cathode active material contains a sodium intercalation compound or a potassium intercalation compound selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrxPO₄F, Se_{z}S_{y} (y/z=0.01 to 100), Se, sodium polysulfide, sulfur, Alluaudites, or a combination thereof, wherein x is from 0.1 to 1.0.

In some embodiments, the cathode active material is selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The layer of an electron-conducting material as an anode or cathode current collector may be a solid foil (e.g. metal foil or conductive polymer film) or a porous layer selected from metal foam, metal web or screen, perforated metal sheet-based 3-D structure, metal fiber mat, metal nanowire mat, conductive polymer nano-fiber mat, conductive polymer foam, conductive polymer-coated fiber foam, carbon foam, graphite foam, carbon aerogel, carbon xerogel, graphene foam, graphene oxide foam, reduced graphene oxide foam, carbon fiber foam, graphite fiber foam, exfoliated graphite foam, or a combination thereof.

The electrolyte may contain a lithium salt, sodium salt, and/or potassium salt dissolved in a liquid solvent and/or a polymer and the liquid solvent may be water, an organic solvent, an ionic liquid, or a mixture of an organic solvent and an ionic liquid. In general, the electrolyte in the anode and the electrolyte in the cathode are identical in a battery, but they can be different in composition. The liquid electrolytes can be an aqueous liquid, organic liquid, ionic liquid (ionic salt having a melting temperature lower than 100° C., preferably lower than room temperature, 25° C.), or a mixture of an ionic liquid and an organic liquid at a ratio from 1/100 to 100/1. The liquid electrolyte preferably contains a sufficient amount of alkali metal salt and/or flame-retardant agent to restrict its movement or is retained in the interstices of polymer chains to reduce its fluidity. The organic liquid is desirable, but the ionic liquid is preferred. A gel electrolyte with limited flowability, quasi-solid electrolyte, polymer electrolyte, or solid-state electrolyte may also be used.

In some embodiments, the anode active material is a pre-lithiated version of graphene sheets selected from pristine graphene, graphene oxide, reduced graphene oxide, graphene fluoride, graphene chloride, graphene bromide, graphene iodide, hydrogenated graphene, nitrogenated graphene, boron-doped graphene, nitrogen-doped graphene, chemically functionalized graphene, a physically or chemically activated or etched version thereof, or a combination thereof. Surprisingly, without pre-lithiation, the resulting lithium battery cell does not exhibit a satisfactory cycle life (i.e. capacity can decay rapidly).

In some embodiments, the cathode active material in this alkali metal battery contains an alkali metal intercalation compound or alkali metal-absorbing compound selected from an inorganic material, an organic or polymeric material, a metal oxide/phosphate/sulfide, or a combination thereof. For example, the metal oxide/phosphate/sulfide may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, transition metal sulfide, or a combination thereof. The inorganic material is selected from sulfur, sulfur compound, lithium polysulfide, transition metal dichalcogenide, a transition metal trichalcogenide, or a combination thereof. In particular, the inorganic material is selected from TiS₂, TaS₂, MoS₂, NbSe₃, MnO₂, CoO₂, an iron oxide, a vanadium oxide, or a combination thereof. These will be further discussed later.

In some embodiments, the cathode active material contains an alkali metal intercalation compound selected from a metal carbide, metal nitride, metal boride, metal dichalcogenide, or a combination thereof. In some embodiments, the cathode active material contains an alkali metal intercalation compound selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form. Preferably, the cathode active material contains a lithium intercalation compound selected from nano discs, nano platelets, nano-coating, or nano sheets of an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein these discs, platelets, or sheets have a thickness less than 100 nm.

In some embodiments, the cathode active material in this alkali metal battery is an organic material or polymeric material selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain including conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio) benzene](PTKPTB, or poly[3,4(ethylenedithio)thiophene](PEDTT).

In a preferred embodiment, the cathode active material is an organic material containing a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

As illustrated in FIG. 1(B), a conventional lithium-ion battery cell is typically composed of an anode current collector (e.g. Cu foil), an anode active material layer coated on the anode current collector (usually two anode active material layers coated on the two primary surfaces of a Cu foil), a porous separator and/or an electrolyte component, a cathode active material layer (usually two cathode active material layers coated on two surfaces of an Al foil), and a cathode current collector (e.g. Al foil). The anode is typically made by (a) preparing a slurry of anode active material particles (e.g. graphite or Si particles), a conductive additive (e.g. carbon black particles), and a resin binder (e.g. SBR or PVDF) dispersed in a liquid medium (e.g. water or an organic solvent, typically NMP); (b) coating the slurry on one or both primary surfaces of a current collector (e.g. Cu foil); and (c) drying the coated slurry to form the dried anode. The cathode layer is also made in a similar manner and the resulting dried anode is composed of a layer or two layers of cathode active material particles (e.g. LFP particles), a conductive additive (e.g. carbon black particles), and a resin binder (e.g. PVDF) coated on a cathode current collector (e.g. Al foil). The conventional cylindrical cell is then made by laminating an anode, a separator, and a cathode layer to form a multi-layer laminate and then rolling this laminate into a cylindrical shape (a roll). Such a roll, containing both an anode and a cathode in the same roll, constitutes a battery cell, which is then inserted into a stainless steel casing, injected with a liquid electrolyte, and then sealed.

In contrast, the instant alkali battery is made by a method comprising: (a) Preparing a plurality of rolled unit cells, wherein each unit cell comprises a cathode, a separator, and an anode that are laminated and wound around an axis into a roll having a roll height between a cathode end and an anode end, wherein the cathode end has a second portion of the cathode current collector being exposed (protruded or extended out beyond the roll height and being substantially free from any cathode active material) and the anode end has the second portion of the anode current collector being exposed (protruded or extended out beyond the roll height and being substantially free from any anode active material coated thereon); and (b) Internally stacking and connecting the plurality of the unit cells in series in such a manner that the exposed second portion of the cathode current collector of a first unit cell roll is in electronic contact with the exposed second portion of the anode current collector of a neighboring unit cell roll to form a high-voltage module. The process may be repeated to produce multiple modules, which are then internally connected in parallel to produce a multiple-module pack. The pack may be housed in a protective casing.

### BRIEF DESCRIPTION OF THE DRAWINGS

FIG. 1(A) Schematic of a prior art lithium metal battery cell (as an example of an alkali metal battery) composed of an anode current collector, an anode electrode layer (e.g. thin Li coating layer or Li foil), a porous separator, a cathode active layer (e.g. NCM or LFP-based layer), and a cathode current collector.

FIG. 1(B) Schematic of a prior art lithium-ion battery cell (as an example of an alkali metal-ion battery), wherein the electrode layer is composed of discrete particles of an active material (e.g. graphite or tin oxide particles in the anode layer or LiCoO₂ in the cathode layer).

FIG. 1(C) Schematic of part of an internal structure of a prior art cylindrical lithium-ion battery cell, indicating the roll contains a laminated structure of an anode layer coated on an anode current collector, a porous separator, and a cathode layer coated on a cathode current collector, which is wound to form a cylindrical roll;

FIG. 1(D) Schematic of a prior art module or pack that contains a plurality of battery cells (each having a protective housing or “can”) that are externally connected in series using connector wires.

FIG. 2(A) Schematic of a unit cell of a cylindrical lithium-ion battery cell, containing a laminated structure of an anode, a separator, and a cathode, which is wound to form a cylindrical roll having a cathode tab (the second portion of a cathode current collector extended or protruded out and bent over to form a positive terminal tab) and a negative terminal tab, according to certain embodiments of present disclosure;

FIG. 2(B) Schematic of a high-voltage module including 2 unit cells stacked and connected in series inside a cylindrical can to form a module or super cell having an output voltage double that of a single cell, according to certain embodiments of present disclosure;

FIG. 2(C) Schematic of another high-voltage module including 2 unit cells stacked and connected in series inside a cylindrical can to form a module or super cell having an output voltage double that of a single cell, wherein the anode tab of a first unit cell and the cathode tab of a second unit cell are connected through a conducting weld/solder/bond, according to certain embodiments of present disclosure;

FIG. 2(D) Schematic of a pack comprising three high-voltage modules connected internally in parallel, wherein each module comprises three unit cells (e.g., units 1-3, 4-6, and 7-9, respectively) connected internally in series, according to certain embodiments of present disclosure.

FIG. 3(A) Schematic of a process for (i) producing a cathode (comprising two cathode active layers coated on the two primary surfaces of a cathode current collector), a separator, and an anode (comprising two anode active layers coated on the two primary surfaces of an anode current collector); (ii) stacking and laminating the cathode, separator, and anode to form a laminate; and (iii) winding a laminate of multiple layers around a mandrel or core to form a cylindrical roll (shown herein) or cuboidal roll (not shown), according to some embodiments of the present disclosure.

FIG. 3(B) Schematic drawing of a process for winding a laminate 26 of multiple layers around a mandrel (30 or 32) to form a cylindrical roll 28 or cuboidal roll 34.

FIG. 4(A) Structure of a high-voltage anode-less alkali metal battery (as manufactured or in a discharged state) according to some embodiments of the present disclosure;

FIG. 4(B) Structure of a high-voltage anode-less alkali metal battery (in a charged state) according to some embodiments of the present disclosure.

FIG. 5 Flow chart illustrating a disclosed process for producing the high-voltage battery module and pack, according to certain embodiments of the present disclosure.

### DETAILED DESCRIPTION

This disclosure provides a high-voltage rolled alkali battery module or pack comprising multiple unit cells internally connected in series. Such a high-voltage battery module/pack exhibits an exceptionally high volumetric energy density that has never been previously achieved for the same type of alkali battery. This alkali battery can be a primary battery, but is preferably a secondary battery selected from a lithium-ion battery or a lithium metal secondary battery (e.g. using lithium metal as an anode active material, including the “anode-less” lithium metal battery), a sodium-ion battery, a sodium metal battery (including the “anode-less” sodium metal battery), a potassium-ion battery, or a potassium metal battery. The present disclosure also claims the lithium ion-sulfur or lithium-sulfur battery (having a sulfur cathode).

The battery is based on a non-aqueous or organic electrolyte, a gel polymer electrolyte, an ionic liquid electrolyte, a solid polymer electrolyte, a solid-state inorganic electrolyte, a polymer/inorganic electrolyte, or a combination thereof. However, the liquid component in an electrolyte is preferably less than 50% by weight, more preferably less than 30%, further preferably less than 20%, and most preferably less than 10% based on the total electrolyte weight. The liquid content, if present, should be sufficiently low to ensure that the electrolyte does not flow from one unit cell to another. The final shape of an alkali battery can be cylindrical, rectangular, cuboidal, etc. The presently disclosed battery module or pack is not limited to any battery shape or configuration.

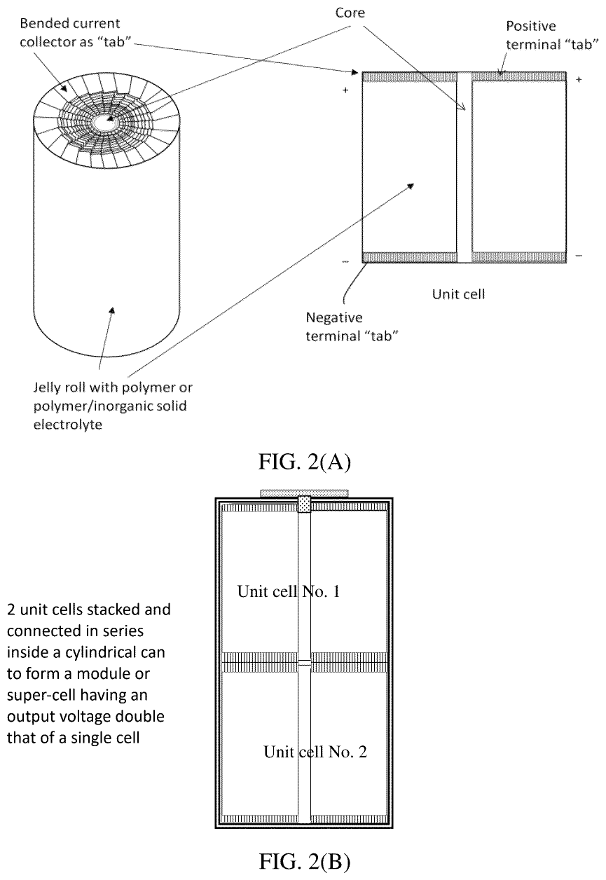

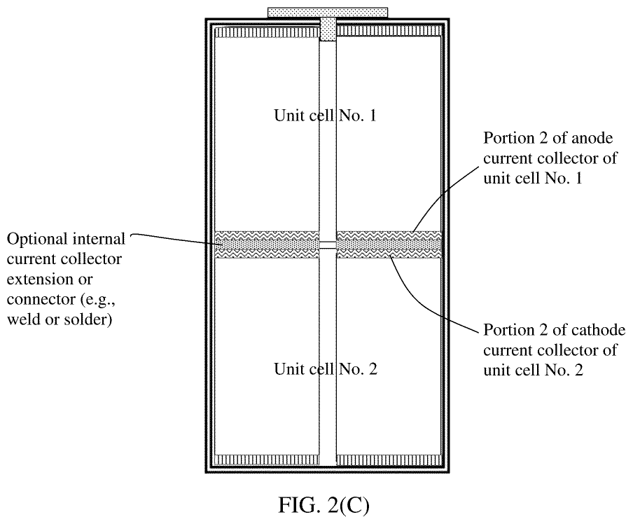

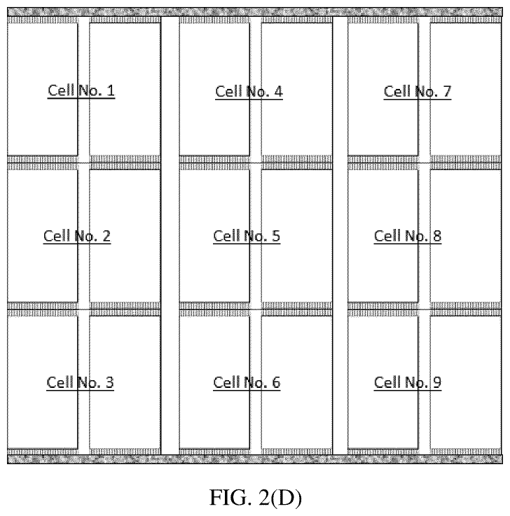

In certain embodiments, as schematically illustrated in FIG. 2(A), 2(B) and 2(C) as examples, the disclosure provides a unit cell having a unique cathode current collector structure and anode current collector structure, a high-voltage module (or super-cell) having a plurality of such unit cells internally connected in series, and a battery pack having multiple high-voltage modules herein disclosed that are internally connected in parallel.

In a brief summary of certain preferred embodiments, the disclosure provides a high-voltage alkali battery, comprising a plurality of unit cells internally connected in series to form a module or pack, wherein each unit cell comprises:
A) a cathode comprising (i) a cathode current collector comprising a conductive material layer or foil having two opposite primary surfaces, herein referred to as a first and a second primary surface, wherein each primary surface has a first portion (intended to be coated with a cathode active layer) and a second portion (intended to be exposed and free from any active material layer and to be bonded to a corresponding second portion of an anode from a neighboring unit cell); and (ii) a first cathode active layer bonded to the first portion, but substantially not the second portion, of the first primary surface and, optionally, a second cathode active layer bonded to the first portion, but substantially not the second portion, of the second primary surface of the cathode current collector, wherein the first or the second cathode active layer comprises a mixture of a cathode active material, an optional resin binder, an electron-conducting additive, and an optional but desirable first electrolyte;
B) an anode comprising (i) an anode current collector comprising a conductive material layer or foil having two opposite primary surfaces (a first and a second primary surface), wherein each primary surface has a first portion and a second portion; and (ii) a first anode active layer bonded to the first portion, but substantially not the second portion, of the first primary surface and, optionally, a second anode active layer bonded to the first portion, but substantially not the second portion, of the second primary surface of the anode current collector, wherein the first or the second anode active layer comprises (ii-a) a mixture of an anode active material, an optional binder, an optional electron-conducting additive, and an optional second electrolyte or (ii-b) a layer of alkali metal or alkali metal alloy having higher than 60% by weight of an alkali metal selected from lithium (Li), sodium (Na), potassium (K) or a combination thereof; and
C) a separator layer, in a form of an ion-permeable material layer or a solid-state electrolyte layer, which is disposed between the anode and the cathode and electrically separating or isolating the anode from the cathode;
where the cathode, the separator, and the anode layer are laminated and wound around an axis into a roll of a unit cell having a roll height (defined to be the width between the cathode end and the anode end of the roll), wherein the cathode end has the second portion of the cathode current collector being protruded or extended out beyond the roll height (and folded or bended to form a positive terminal “tab”, as illustrated in FIG. 2(A)) and not touching the anode current collector and wherein the anode end has the second portion of the anode current collector being protruded or extended out beyond the roll height (and folded or bended to form a negative terminal “tab”) and not touching the cathode current collector; wherein,
the plurality of the unit cells are internally stacked and connected in such a manner that the protruded or extended out second portion (positive “tab”) of the cathode current collector of a first unit cell roll is in electronic contact with (e.g., welded, soldered, or bonded with) the protruded or extended out second portion (negative “tab”) of the anode current collector of a second, neighboring unit cell roll (as illustrated in FIG. 2(B)), and wherein the first electrolyte and the second electrolyte are the same as or different from each other and all having an ion conductivity no less than 10⁻⁷ S/cm (preferably from 10⁻⁶ S/cm to 5×10⁻² S/cm) and the electrolytes are not flowable wherein the electrolyte in a unit cell is not capable of flowing to and does not flow to a neighboring unit cell.

Preferably, the first or the second electrolyte is selected from a flexible electrolyte that does not flow easily (will not flow from one unit cell to another). Such an electrolyte may be selected from a solid polymer electrolyte, inorganic electrolyte, polymer/inorganic composite electrolyte, a quasi-solid electrolyte having an alkali salt concentration no less than 2.5 M in an organic or ionic liquid solvent, or a semi-solid electrolyte having a liquid content less than 30% by weight of the total electrolyte weight. Being flexible is essential to winding the laminate around an axis to form a roll.

The anode or cathode current collector preferably comprises a conductive material layer or foil having a thickness from 10 nm to 100 μm, preferably thinner than 20 μm and more preferably between 2 and 12 μm.

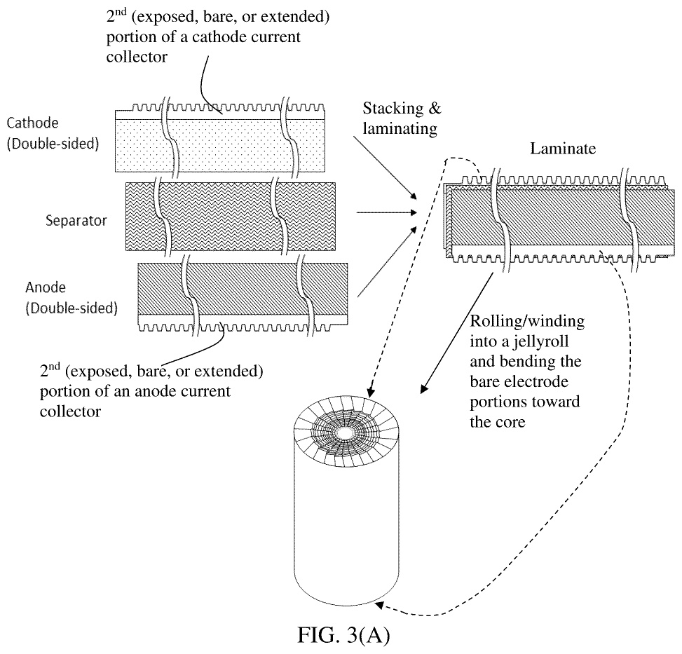

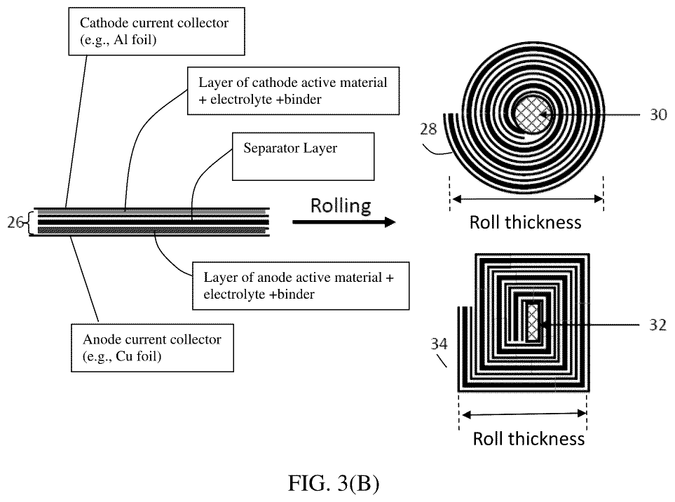

Schematically shown in FIG. 2(A) is a unit cell of a cylindrical lithium-ion or lithium metal battery, containing a laminated structure of an anode, a separator, and a cathode which are wound to form a cylindrical roll having a cathode tab (the second or bare portion of a cathode current collector extended or protruded out above the roll width and bent over to form a positive terminal tab) and a negative terminal tab (the second or bare portion of an anode current collector extended or protruded out above the roll width and bent over to form a negative terminal tab), according to certain embodiments of present disclosure. The second portion of a current collector is the bare portion (also referred to as an exposed portion, extended portion, or protruded out portion) that is not coated with any material such as a cathode or anode active material. The bare portion of the anode current collector also may be bent over toward the core in a similar fashion to make a negative tab. The second portion of a cathode current collector of a unit cell (say, Unit cell No. 1), as illustrated at the top left portion of FIG. 3(A), is meant to be connected to either an external terminal (+terminal) of a high-voltage module or internally connected to the second portion of an anode current collector of a neighboring unit cell (say, Unit cell No. 2).

Similarly, as illustrated at the bottom left portion of FIG. 3(A), the second portion of a current collector of a unit cell is meant to be connected to either an external terminal (−terminal) of a high-voltage module or internally connected to the second portion of a cathode current collector of a neighboring unit cell.

FIG. 2(B) schematically shows a high-voltage module including 2 unit cells stacked and connected in series inside a cylindrical can to form a high-voltage module or “super cell” having an output voltage double that of a single cell, according to certain embodiments of present disclosure. The anode tab of a first unit cell and the cathode tab of a second unit cell are directly connected to each other via welding, soldering, adhesive bonding, mechanical bonding, etc.

FIG. 2(C) schematically illustrates another high-voltage module including 2 unit cells stacked and connected in series inside a cylindrical can to form a module or super-cell having an output voltage double that of a single cell, wherein the anode tab of a first unit cell and the cathode tab of a second unit cell are connected through a conducting weld/solder/bond, according to certain embodiments of present disclosure;

FIG. 2(D) schematically shows a pack comprising three high-voltage modules connected internally in parallel, wherein each module comprises three unit cells (e.g., units 1-3, 4-6, and 7-9, respectively) connected internally in series, according to certain embodiments of present disclosure.

As schematically illustrated in FIG. 3(A) and 3(B), a unit cell roll is basically obtained by laminating multi-layers of different materials to form a laminate and then winding the laminate into a wound roll shape. FIG. 3(B) schematically shows a drawing of a process for winding a laminate 26 of multiple layers around a mandrel (30 or 32) to form a cylindrical roll 28 or cuboidal roll 34.

For convenience, we will use selected materials, such as lithium iron phosphate (LFP), vanadium oxide (VₓO_{y}), lithium nickel manganese cobalt oxide (NMC), dilithium rhodizonate (Li₂C₆O₆), and copper phthalocyanine (CuPc), as illustrative examples of the cathode active material, and graphite or hard carbon, Li foil, Na foil, Co₃O₄, and Si particles as examples of the anode active material. For sodium batteries, we will use selected materials, such as NaFePO₄ and λ-MnO₂ particles, as illustrative examples of the cathode active material, and hard carbon and NaTi₂(PO₄)₃ particles as examples of the anode active material of a Na-ion cell. Similar approaches are applicable to K-ion batteries.

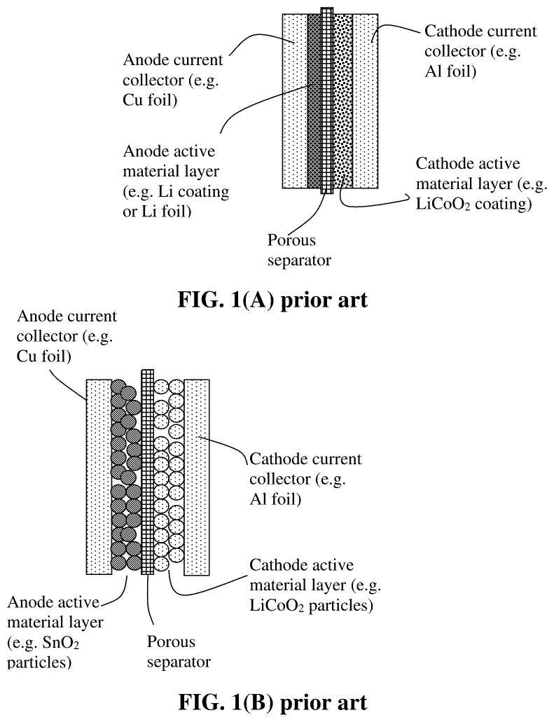

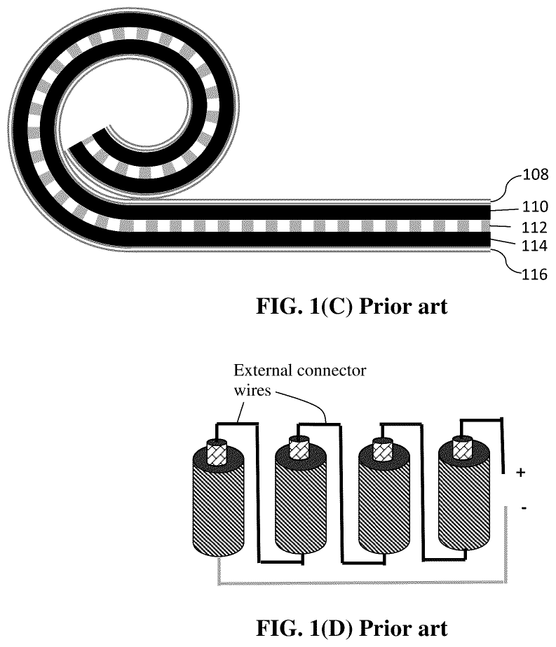

As illustrated in FIG. 1(A), 1(B), and 1(C), a conventional lithium-ion battery cell is typically composed of an anode current collector (e.g. Cu foil), an anode active material layer coated on the anode current collector, a porous separator and/or an electrolyte component, a cathode active material layer coated on the two primary surfaces of a cathode current collector, and a cathode current collector (e.g. Al foil). Although only one anode layer is shown, there can be two anode active material layers coated on the two primary surfaces of the anode current collector. Similarly, there can be two cathode active material layers coated on the two primary surfaces of the cathode current collectors.

In a commonly used cell configuration (FIG. 1(B)), the anode layer is composed of particles of an anode active material (e.g. graphite or Si), a conductive additive (e.g. carbon black particles), and a resin binder (e.g. SBR or PVDF). The cathode layer is composed of particles of a cathode active material (e.g. LFP particles), a conductive additive (e.g. carbon black particles), and a resin binder (e.g. PVDF). Both the anode and the cathode layers are typically up to 100-200 μm thick to give rise to a presumably sufficient amount of current per unit footprint electrode area.

In another cell configuration, as illustrated in FIG. 1(A), the anode active material (e.g. Li metal) is deposited in a thin film form directly onto a current collector, such as a sheet of copper foil. Such a battery is commonly referred to as a lithium metal battery.

The prior art lithium battery cell is typically made by a process that includes the following steps: (a) The first step includes mixing particles of the anode active material (e.g. Si nano particles or meso-carbon micro-beads, MCMBs), a conductive filler (e.g. graphite flakes), a resin binder (e.g. PVDF) in a solvent (e.g. NMP) to form an anode slurry. On a separate basis, particles of the cathode active material (e.g. LFP particles), a conductive filler (e.g. acetylene black), a resin binder (e.g. PVDF) are mixed and dispersed in a solvent (e.g. NMP) to form a cathode slurry. (b) The second step includes coating the anode slurry onto one or both primary surfaces of an anode current collector (e.g. Cu foil), drying the coated layer by vaporizing the solvent (e.g. NMP) to form a dried anode electrode coated on Cu foil. Similarly, the cathode slurry is coated and dried to form a dried cathode electrode coated on Al foil. Slurry coating is normally done in a roll-to-roll manner in a real manufacturing situation; (c) The third step includes laminating an anode/Cu foil sheet, a porous separator layer, and a cathode/Al foil sheet together to form a 3-layer or 5-layer assembly, which is cut and slit into desired sizes and stacked to form a rectangular structure (as an example of shape) or rolled into a cylindrical cell structure. (d) The rectangular or cylindrical laminated structure is then encased in an aluminum-plastic laminated envelope or steel casing (a can, for instance). (e) A liquid electrolyte is then injected into the laminated structure to make a lithium battery cell.

There are several serious drawbacks or problems associated with the conventional process and the resulting lithium-ion battery cell, sodium-ion cell, and potassium-ion cell:
1) The conventional process requires dispersing electrode active materials (anode active material or cathode active material) in a liquid solvent (e.g. NMP) to make a slurry and, upon coating on a current collector surface, the liquid solvent has to be removed to dry the electrode layer. Once the anode and cathode layers, along with a separator layer, are laminated together and packaged in a housing to make a battery cell, one then injects a liquid electrolyte into the cell. In actuality, one makes the two electrodes wet, then makes the electrodes dry, and finally makes them wet again. Such a wet-dry-wet process does not sound like a good process at all. The presently disclosed process can be a relatively liquid-free solid or semi-solid process that is faster and more cost-effective. The battery cell, once made, typically does not require injection of liquid electrolyte. The batteries herein disclosed are also more flame/fire-resistant.
2) Current lithium-ion batteries still suffer from a relatively low gravimetric energy density and low volumetric energy density. Commercially available lithium-ion batteries exhibit a gravimetric energy density of approximately 180-260 Wh/kg and a volumetric energy density of 500-650 Wh/L. The presently disclosed batteries enable the production of batteries that are capable of delivering a specific energy from 300 Wh/kg to 600 Wh/kg.
3) Schematically shown in FIG. 1(C) is a part of an internal structure of a prior art cylindrical lithium-ion battery cell, indicating that each battery cell contains a roll, which is composed of a laminate of an anode layer 110 coated on an anode current collector 108, a porous separator 112, and a cathode layer 114 coated on a cathode current collector 116. Each roll contains both the anode and the cathode active material layers therein. There is only one roll or one unit cell inside a protective housing (e.g., a cylindrical steel can).

Typically, a traditional lithium-ion cell provides an output voltage of from 3.2 volts (graphite anode and lithium iron phosphate, LFP, cathode) to 3.7 volts (graphite anode and NCM cathode); a lithium-sulfur cell provides an output voltage of 2.1 volts. In a conventional battery module or pack, multiple cells are joined in series to build higher voltage units (FIG. 1(D)) or in parallel to build higher charge capacity units. These connections result in significant weight and volume overhead added to the battery (lots of connectors and/or connecting wires used). In addition, each cell is provided with a housing (a can) that can add weight, volume, and cost to a battery cell. The presently disclosed high-voltage battery module and pack overcomes these drawbacks via an internal connection strategy vs. external connection.

Now, with two unit cells internally connected in series inside a cylindrical can (according to certain embodiments of the present disclosure), the output voltage from the can (e.g., a module of two unit cells) is 6.4 volts and 7.4 volts, respectively and yet there is only one protective housing (one cylindrical stainless steel can, for instance) and no external connecting wires. The output voltage of a module of n unit cells will be from 3.2n to 3.7n volts, which requires only one can (rather than n cans), where n is from 2 to 1,000 (no theoretical upper limit), preferably from 2 to 250. This type of internal connection (e.g., the anode end tab of a unit cell directly merged with or connected to the cathode end tab of an adjacent unit cell with minimal interfacial resistance) enables a battery system with lower amounts of inactive materials, lower packing volume, lower packing weight, lower materials and processing costs, lower battery system impedance (hence, a higher power density), and a higher pack-level energy density (due to a significantly reduced overhead weight).

As illustrated in FIG. 2(A) and 2(B) as one example, the internal series connection (ISC) technology involves connecting a desired number of unit cells in an end tab-to-end tab manner inside a single can. The end tab-to-end tab connection may be accomplished via a weld, solder, chemical bond (e.g., through a graphene-reinforced epoxy adhesive), an intermediate conductive layer (e.g., as in FIG. 2(C)), or a simple physical or mechanical contact.

In this ISC configuration, only two terminal electrodes are externally connected to the outside circuit and all the intermediate unit cells are isolated from the outside circuit. The positive terminal and the negative terminal should be electrically isolated from one another by using any separating means (e.g., external and/or internal rubber gaskets) known in the art. Series connection provides a high voltage output (high V), which is the sum of the voltage values of all cells: for instance, if one sodium-ion unit cell gives 3.1 volts, then two cells 6.2 volts, and n cells 3.1n volts, etc. The number n can be any integer that is 2 or greater than 2 (for practical purposes, n is from 2 to 1,000).

The number of unit cells in a stack or module depends upon the needed output voltage of the stack. Using a unit cell voltage of 3.1 volts as a basis, a sodium-ion battery stack for use in an electric power scooter (48V), for instance, will require 16 unit cells connected in series. Such a stack constitutes a sodium-ion battery “element” or module which, if inserted into a casing and fitted with a PC board (control electronics), makes a great power module.

There is nothing in battery industry that features an 18650-type cylindrical battery (18 mm diameter and 165 mm length) or any cylindrical battery cell that can deliver a battery voltage higher than 4.0 volts. Further, the instant invention enables design and construction of a battery that can have essentially any output voltage. These are some additional surprising and useful features of the presently invented high-voltage rolled alkali cells.

Additionally, multiple high-voltage battery modules may be internally connected in parallel to form an alkali battery pack that can deliver massive power and energy. A preferred and unique configuration of such a battery pack is illustrated in FIG. 2(D), wherein multiple high-voltage modules being parallel to each other are packed together and internally connected in parallel to form a pack with a dramatically increased battery capacity (Amp-hours, or Ah). There is no theoretical limitation on the number of modules in such a high-voltage battery pack.

The output voltage is typically the same as the output voltage of the constituent modules (provided these modules are substantially identical in composition and structure). However, the output current can be massive since there are large amounts of active materials contained in such a battery pack. As illustrated in FIG. 2(D), the high-voltage battery pack is preferably protected by a protective housing, allowing at least two terminals protruded out of the housing unit for connecting to outside circuit. Insulating gaskets may be used to prevent any internal shorting caused by a contact between the negative terminal and positive terminal of a module.

The disclosed high-voltage sodium battery can be a sodium-ion battery or a sodium metal battery, the latter having sodium metal as the primary anode active material. The sodium metal battery can have sodium metal implemented at the anode when the battery is made.

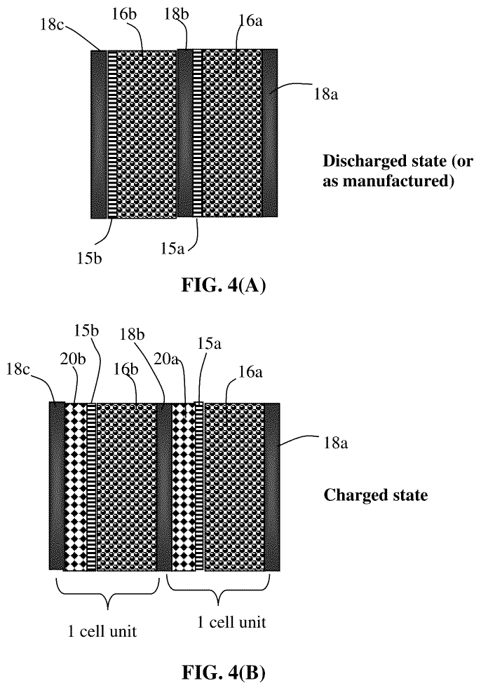

Alternatively, the sodium may be stored in the cathode active material and the anode side is sodium metal-free initially. This is called an anode-less sodium metal battery. Thus, in certain embodiments, as illustrated in FIG. 4(A), the rechargeable high-voltage sodium battery is a sodium metal battery wherein the anode has a primary surface of the anode current collector that initially does not have any sodium or sodium alloy as an anode active material supported by the anode current collector when the battery cell is made and prior to a charge or discharge operation of the battery. In this situation, the sodium ions are initially stored in the cathode, as part of a cathode active material.

As illustrated in FIG. 4(A), the high-voltage anode-less sodium battery is in an as-manufactured or fully discharged state according to certain embodiments of the present disclosure. The battery comprises multiple cells, wherein a cell comprises a separator (e.g., 15a, 15b), a cathode active layer (e.g., 16a, 16b) supported on a cathode current collector (e.g., 18a, 18b), and an anode current collector (e.g., 18b, 18c) having one primary surface initially being free from any sodium metal. Each cathode active layer comprises a cathode active material, a conductive additive (not shown), an optional resin binder (not shown), and an electrolyte (dispersed in the entire cathode active layer and in contact with the cathode active material as a part of a layer). There is no sodium metal in the anode side, only an anode current collector like a Cu foil, initially when the battery is manufactured.

In a charged state, as illustrated in FIG. 4(B), the battery comprises a sodium metal (20a, 20b) plated on the primary surface of an anode current collector (18b, 18c), a separator (15a, 15b), and a cathode active (16a, 16b). The sodium metal comes from the cathode active material (e.g., Na-containing layer metal oxide) that contains Na element when the cathode is made.

During a charging step, sodium ions are released from the cathode active material in the cathode active layer and move to the anode side to deposit onto a primary surface of the anode current collector for forming a sodium metal layer, which is the anode active material.

One unique feature of the presently disclosed high-voltage anode-less sodium battery (also anodeless lithium or potassium metal battery) is the notion that there is substantially no anode active material and no sodium metal (or Li or K metal) is present when the battery is made. The commonly used anode active material, such as an intercalation type anode material (e.g., hard carbon particles) or any conversion-type anode material, is not included in the battery.

The anode only contains a current collector or a protected current collector. No sodium metal (e.g., Na particle, surface-stabilized Na particle, Na foil, Na chip, etc.) is present in the anode when the battery is made; sodium is basically stored in the cathode (e.g., sodium transition metal oxides, oxoanions, etc.). During the first charge procedure after the battery is sealed in a housing (e.g., a stainless steel hollow cylinder or an Al/plastic laminated envelop), sodium ions are released from these Na-containing compounds (cathode active materials) in the cathode roll, travel through the electrolyte/separator into the anode side, and get deposited on the surface of an anode current collector. During a subsequent discharge procedure, sodium ions leave this surface and travel back to the cathode, intercalating or inserting into the cathode active material. Similarly, one can have an anodeless high-voltage lithium metal battery and anodeless high-voltage potassium metal battery.

Such an anode-less high-voltage battery is much simpler and more cost-effective to produce as compared to the conventional sodium-ion battery since there is no need to have a layer of anode active material (e.g., hard carbon particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 prm thick), the weight and volume of the cell can be significantly reduced, thereby increasing the gravimetric and volumetric energy density of the battery. This advantage is in addition to the advantage that there are substantially no connecting wires or cables between two unit cells, further saving the weight, volume, and cost.

Another important advantage of the anode-less battery is the notion that there is no sodium metal in the anode when a sodium metal cell is made. Sodium metal (e.g., Na metal foil and particles) is highly sensitive to air moisture and oxygen and notoriously known for its difficulty and danger to handle during manufacturing of a Na metal battery. The manufacturing facilities should be equipped with special class of dry rooms, which are expensive and significantly increase the battery cell costs.

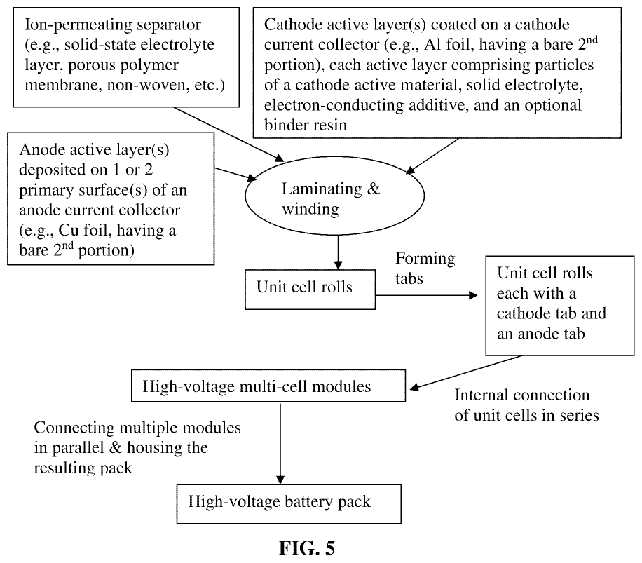

As schematically illustrated in FIG. 3(A) and FIG. 5, the high-voltage alkali battery may be produced by a presently disclosed method, which comprises: (a) preparing a plurality of rolled unit cells, wherein each unit cell comprises a cathode, a separator, and an anode that are laminated and wound around an axis into a roll having a roll height between a cathode end and an anode end, wherein the cathode end has a second portion of the cathode current collector being exposed, protruded or extended out beyond the roll height and being substantially free from any cathode active material and the anode end has the second portion of the anode current collector being exposed, protruded or extended out beyond the roll height and being substantially free from any anode active material coated thereon; (b) shaping the second portion of the cathode current collector into a cathode tab (e.g., by bending the bare portion toward the core) and shaping the second portion of the anode current collector into an anode tab (e.g., by bending the bare portion toward the core); and (c) internally stacking and connecting the plurality of the unit cells in series in such a manner that the exposed second portion of the cathode current collector of a first unit cell roll is in electronic contact with the exposed second portion of the anode current collector of a neighboring unit cell roll to form a high-voltage module.

In some embodiments, step c) comprises connecting the exposed second portion of the cathode current collector of a first unit cell roll to the exposed second portion of the anode current collector of a neighboring unit cell roll through welding, soldering, chemical bonding (e.g., bonded with a graphene/epoxy composite adhesive), mechanical interlocking, physical contact (preferably with an intimate face-to-face contact), or a combination thereof.

These procedures may be repeated to produce multiple high voltage modules each comprising a plurality of rolled unit cells internally stacked and connected in series, and the method further comprises; (d) connecting the multiple high-voltage modules in parallel internally to form a multiple-stack pack; and (e) encasing the multiple-stack pack in a protective housing to form a desired battery pack.

In certain embodiments, the rechargeable sodium cell is a sodium metal cell wherein the anode has an anode current collector and an amount of sodium or sodium alloy (e.g., in the form of powder, coating, or thin film) as an anode active material supported by the anode current collector.

In some embodiments, the rechargeable sodium cell is a sodium-ion cell wherein the anode active material contains an alkali intercalation compound, sodium alloying materials, or conversion material.

The layer of conductive material, as a current collector, may be a solid metal foil (e.g. thin Cu foil or Al foil, 4-20 μm thick) or an electrically conductive porous layer selected from metal foam, metal web or screen, perforated metal sheet-based structure, metal fiber mat, metal nanowire mat, conductive polymer nano-fiber mat, conductive polymer foam, conductive polymer-coated fiber foam, carbon foam, graphite foam, carbon aerogel, carbon xerogel, graphene foam, graphene oxide foam, reduced graphene oxide foam, carbon fiber foam, graphite fiber foam, exfoliated graphite foam, or a combination thereof. The porous layers should be made of an electrically conductive material, such as a carbon, graphite, metal, metal-coated fiber, conductive polymer, or conductive polymer-coated fiber, which is in a form of porous mat, screen/grid, non-woven, foam, etc. Such layers are usually flexible, enabling the winding operation to form into a roll shape.

In some embodiments, the electron-conducting material (as a conductive additive or as a current collector) contains graphene sheets selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. The starting graphitic material for producing any one of the above graphene materials may be selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof. Graphene materials are also a good conductive additive for both the anode and cathode active materials of an alkali metal battery. Production processes for these graphene sheets are known in the art.

The pore walls in these porous layers form a 3-D network of interconnected electron-transporting pathways with minimal resistance. Additionally, in each anode electrode or cathode electrode layer, the electrode active material particles are pre-mixed with a solid-state electrolyte, preferably comprising particles of an inorganic solid electrolyte dispersed in a polymer electrolyte.

There is no restriction on the types of anode active materials or cathode active materials that can be used in practicing the instant invention. Preferably, in the invented high-voltage battery or production process, the anode active material absorbs alkali ions (e.g. lithium ions) at an electrochemical potential of less than 1.0 volt (preferably less than 0.7 volts) above the Li/Li⁺(i.e. relative to Li →Li⁺+e⁻ as the standard potential, or with respect to the Na/Na⁺ reference if a sodium battery) when the battery is charged. In one preferred embodiment, the anode active material is selected from the group consisting of: (a) Particles of natural graphite, artificial graphite, meso-carbon microbeads (MCMB), and carbon (including soft carbon, hard carbon, carbon nano-fiber, and carbon nano-tube); (b) Silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd); (Si, Ge, Al, and Sn are most desirable due to their high specific capacities.) (c) Alloys or intermetallic compounds of Si, Ge, Sn, Pb, Sb, Bi, Zn, Al, or Cd with other elements, wherein the alloys or compounds are stoichiometric or non-stoichiometric (e.g. SiAl, SiSn); (d) Oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites (e.g. SnO, TiO₂, Co₃O₄, etc.); (e) Pre-lithiated versions thereof (e.g. pre-lithiated TiO₂, which is lithium titanate); (f) Pre-lithiated graphene sheets; and combinations thereof.

In the high-voltage rechargeable alkali battery, the anode may contain an alkali ion source selected from an alkali metal, an alkali metal alloy, a mixture of alkali metal or alkali metal alloy with an alkali intercalation compound, an alkali element-containing compound, or a combination thereof. Particularly desired is an anode active material that contains an alkali intercalation compound selected from petroleum coke, carbon black, amorphous carbon, hard carbon, templated carbon, hollow carbon nanowires, hollow carbon sphere, titanates, NaTi₂(PO₄)₃, Na₂Ti₃O₇(Sodium titanate), Na₂CsH₄O₄(Disodium Terephthalate), Na₂TP (Sodium Terephthalate), TiO₂, NaxTiO₂ (x=0.2 to 1.0), carboxylate based materials, C₈H₄Na₂O₄, C₈H₆O₄, CsH₅NaO₄, C₈Na₂F₄O₄,C₁₀H₂Na₄O₈, C₁₄H₄O₆, C₁₄H₄Na₄O₈, or a combination thereof.

In an embodiment, the anode may contain a mixture of 2 or 3 types of anode active materials (e.g. mixed particles of activated carbon+NaTi₂(PO₄)₃) and the cathode can be a sodium intercalation compound alone (e.g. NaxMnO₂), an electric double layer capacitor-type cathode active material alone (e.g. activated carbon), a redox pair of X—MnO₂/activated carbon for pseudo-capacitance.

A wide variety of cathode active materials can be used to practice the presently invented high-voltage battery and related process. The cathode active material typically is an alkali metal intercalation compound or alkali metal-absorbing compound that is capable of storing alkali metal ions when the battery is discharged and releasing alkali metal ions into the electrolyte when rec-charged. The cathode active material may be selected from an inorganic material, an organic or polymeric material, a metal oxide/phosphate/sulfide (most desired types of inorganic cathode materials), or a combination thereof.

The group of metal oxide, metal phosphate, and metal sulfides including lithium cobalt oxide, lithium nickel oxide, lithium manganese oxide, lithium vanadium oxide, lithium transition metal oxide, lithium-mixed metal oxide, lithium iron phosphate, lithium manganese phosphate, lithium vanadium phosphate, lithium mixed metal phosphates, transition metal sulfides, and combinations thereof. In particular, the lithium vanadium oxide may be selected from the group consisting of VO₂, LixVO₂, V₂O₅, LixV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

Lithium transition metal oxide may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In the alkali metal cell or alkali metal-ion cell, the cathode active material may contain a sodium intercalation compound (or their potassium counterparts) selected from NaFePO₄ (Sodium iron phosphate), Na_{0.7}FePO₄, Na_{1.5} VOPO₄F_{0.5}, Na₃V₂(PO₄)₃, Na₃V₂(PO₄)₂F₃, Na₂FePO₄F, NaFeF₃, NaVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂ (Sodium cobalt oxide), Na_{2/3}[Ni_{1/3}Mn_{2/3}]O₂, Naₓ(Fe_{1/2}Mn_{1/2})O₂, NaₓMnO₂ (Sodium manganese bronze), λ-MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF (Copper and nickel hexacyanoferrate), NiHCF (nickel hexacyanoferrate), NaₓCoO₂, NaCrO₂, Na₃Ti₂(PO₄)₃, NiCo₂O₄, Ni₃S₂/FeS₂, Sb₂O₄, Na₄Fe(CN)₆/C, NaV₁₋ₓCrxPO₄F, Se_{y}S_{z} (Selenium and Selenium/Sulfur, z/y from 0.01 to 100), Se (without S), Alluaudites, or a combination thereof.

Other inorganic materials for use as a cathode active material may be selected from sulfur, sulfur compound, lithium polysulfide, sodium polysulfide, potassium polysulfide, transition metal dichalcogenide, a transition metal trichalcogenide, or a combination thereof. In particular, the inorganic material is selected from TiS₂, TaS₂, MoS₂, NbSe₃, MnO₂, CoO₂, an iron oxide, a vanadium oxide, or a combination thereof. These will be further discussed later.

In particular, the inorganic material may be selected from: (a) bismuth selenide or bismuth telluride, (b) transition metal dichalcogenide or trichalcogenide, (c) sulfide, selenide, or telluride of lithium, sodium, potassium, niobium, zirconium, molybdenum, hafnium, tantalum, tungsten, titanium, cobalt, manganese, iron, nickel, or a transition metal; (d) boron nitride, or (e) a combination thereof.

Alternatively, the cathode active material may be selected from a functional material or nano-structured material having an alkali metal ion-capturing functional group or alkali metal ion-storing surface in direct contact with the electrolyte. Preferably, the functional group reversibly reacts with an alkali metal ion, forms a redox pair with an alkali metal ion, or forms a chemical complex with an alkali metal ion. The functional material or nano-structured material may be selected from the group consisting of (a) a nano-structured or porous disordered carbon material selected from a soft carbon, hard carbon, polymeric carbon or carbonized resin, meso-phase carbon, coke, carbonized pitch, carbon black, activated carbon, nano-cellular carbon foam or partially graphitized carbon; (b) a nano graphene platelet selected from a single-layer graphene sheet or multi-layer graphene platelet; (c) a carbon nanotube selected from a single-walled carbon nanotube or multi-walled carbon nanotube; (d) a carbon nano-fiber, nano-wire, metal oxide nano-wire or fiber, conductive polymer nano-fiber, or a combination thereof; (e) a carbonyl-containing organic or polymeric molecule; (f) a functional material containing a carbonyl, carboxylic, or amine group; and combinations thereof.

The functional material or nano-structured material may be selected from the group consisting of Poly(2,5-dihydroxy-1,4-benzoquinone-3,6-methylene), NaₓC₆O₆ (x=1-3), Na₂(C₆H₂O₄), Na₂C₈H₄O₄(Na terephthalate), Na₂C₆H₄O₄(Li trans-trans-muconate), 3,4,9,10-perylenetetracarboxylicacid-dianhydride (PTCDA) sulfide polymer, PTCDA, 1,4,5,8-naphthalene-tetracarboxylicacid-dianhydride (NTCDA), Benzene-1,2,4,5-tetracarboxylic dianhydride, 1,4,5,8-tetrahydroxy anthraquinon, Tetrahydroxy-p-benzoquinone, and combinations thereof. Desirably, the functional material or nano-structured material has a functional group selected from —COOH, ═O, —NH₂, —OR, or —COOR, where R is a hydrocarbon radical.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain including conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene](PTKPTB, or poly[3,4(ethylenedithio)thiophene](PEDTT).

The organic material may be selected from a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The lithium intercalation compound or lithium-absorbing compound may be selected from a metal carbide, metal nitride, metal boride, metal dichalcogenide, or a combination thereof. Preferably, the lithium intercalation compound or lithium-absorbing compound is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form.

We have discovered that a wide variety of two-dimensional (2D) inorganic materials can be used as a cathode active material in the presented invented lithium battery prepared by the invented direct active material-electrolyte injection process. Layered materials represent a diverse source of 2D systems that can exhibit unexpected electronic properties and good affinity to lithium ions. Although graphite is the best known layered material, transition metal dichalcogenides (TMDs), transition metal oxides (TMOs), and a broad array of other compounds, such as BN, Bi₂Te₃, and Bi₂Se₃, are also potential sources of 2D materials.

Preferably, the lithium intercalation compound or lithium-absorbing compound is selected from nano discs, nano platelets, nano-coating, or nano sheets of an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein the discs, platelets, or sheets have a thickness less than 100 nm. The lithium intercalation compound or lithium-absorbing compound may contain nano discs, nano platelets, nano-coating, or nano sheets of a compound selected from: (i) bismuth selenide or bismuth telluride, (ii) transition metal dichalcogenide or trichalcogenide, (iii) sulfide, selenide, or telluride of niobium, zirconium, molybdenum, hafnium, tantalum, tungsten, titanium, cobalt, manganese, iron, nickel, or a transition metal; (iv) boron nitride, or (v) a combination thereof, wherein the discs, platelets, coating, or sheets have a thickness less than 100 nm.

Non-graphene 2D nano materials, single-layer or few-layer (up to 20 layers), can be produced by several methods: mechanical cleavage, laser ablation (e.g. using laser pulses to ablate TMDs down to a single layer), liquid phase exfoliation, and synthesis by thin film techniques, such as PVD (e.g. sputtering), evaporation, vapor phase epitaxy, liquid phase epitaxy, chemical vapor epitaxy, molecular beam epitaxy (MBE), atomic layer epitaxy (ALE), and their plasma-assisted versions.

A wide range of electrolytes can be used for practicing the instant invention, including non-aqueous organic liquid electrolyte, ionic liquid electrolyte, quasi-solid electrolyte, gel polymer electrolyte, solid polymer electrolyte, inorganic electrolyte, polymer/inorganic composite electrolyte, or a combination thereof. The electrolyte can be present in the active material layer. The non-aqueous liquid electrolyte to be employed herein may be produced by dissolving an electrolytic salt (Li salt, Na salt, and/or K salt) in a non-aqueous solvent with a salt concentration preferably greater than 2.5M (herein referred to as a quasi-solid electrolyte). The salt concentration in a quasi-solid electrolyte is preferably higher than 3.0M. It is essential to make the electrolyte non-flowable, not to flow from one unit cell to another. Any known non-aqueous solvent which has been employed as a solvent for a lithium secondary battery can be employed.

The alkali metal salt to be dissolved in a liquid solvent or dispersed in a polymer may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluorornethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl)malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaxSOy, wherein X=F, Cl, I, or Br, R=a hydrocarbon group, x=0-1, y =1-4, an ionic liquid-based sodium salt, or a combination thereof, or a potassium counterpart thereof.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation). There is no restriction on what type of ionic liquid that can be used.

A typical and well-known ionic liquid is formed by the combination of a 1-ethyl-3-methylimidazolium (EMI) cation and an N,N-bis(trifluoromethane)sulphonamide (TFSI) anion.

This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a supercapacitor.

There is no restriction on the type of solid state electrolyte that can be used for practicing the instant invention. The solid state electrolytes can be selected from a solid polymer-, metal oxide type (e.g. LIPON), solid sulfide type (e.g. Li₂S—P₂S₅), halide-type, hydride-type, and nitride-type, etc. The inorganic solid electrolyte material for use in a high-voltage sodium batterymay be selected from Nasicon, beta-alumina, sulfide-type, complex hydride-type, and/or certain glass or ceramic particles, preferably having a diameter from 5 nm to 5 μm.

In the high-voltage pack, the solid polymer electrolyte or gel polymer electrolyte preferably comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

The inorganic solid electrolyte material for use in a high-voltage lithium battery may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ (PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

As schematically illustrated in FIG. 5 and according to certain embodiments of instant disclosure, a method of producing the disclosed high-voltage battery comprises: (a) preparing a plurality of rolled unit cells, wherein each unit cell comprises a cathode, a separator, and an anode that are laminated and wound around an axis into a roll having a roll height between a cathode end and an anode end, wherein the cathode end has a second portion of the cathode current collector being exposed (protruded or extended out beyond the roll height and being substantially free from any cathode active material) and the anode end has the second portion of the anode current collector being exposed (protruded or extended out beyond the roll height and being substantially free from any anode active material coated thereon); and (b) Internally stacking and connecting the plurality of the unit cells in series in such a manner that the exposed second portion of the cathode current collector of a first unit cell roll is in electronic contact with the exposed second portion of the anode current collector of a neighboring unit cell roll to form a high-voltage module. The process may be repeated to produce multiple modules, which are then internally connected in parallel to produce a multiple-module pack. The pack may be housed in a protective casing.

The cathode or anode preferably comprises an electrolyte selected from a quasi-solid electrolyte, a gel polymer electrolyte, a solid polymer electrolyte, an inorganic electrolyte, or an inorganic/polymer composite electrolyte.

The anode layer may be made by mixing and coating an anode active layer onto at least a primary surface of an anode current collector. The anode active layer preferably comprises a mixture of an anode active material, an optional binder resin, an optional electron-conducting additive, and an optional electrolyte (preferably a quasi-solid electrolyte, a gel polymer electrolyte, a solid polymer electrolyte, an inorganic electrolyte, or an inorganic/polymer composite electrolyte). This can be produced by using a conventional slurry coating process, but preferably by using any known dry solid-state process with no or minimal liquid involved A high-voltage battery module or pack may be produced by a method comprising connecting a plurality of the unit cells (rolls) internally in series. Multiple high-voltage modules may be internally connected in parallel to form a higher capacity pack.

In what follows, we provide examples for a large number of different types of anode active materials, cathode active materials, and conductive material layers (e.g. Cu foil, Al foil, graphite foam, graphene foam, and metal foam) to illustrate the best mode of practicing the instant invention. Theses illustrative examples and other portions of instant specification and drawings, separately or in combinations, are more than adequate to enable a person of ordinary skill in the art to practice the instant invention. However, these examples should not be construed as limiting the scope of instant invention.

The inorganic solid electrolytes described below in Examples 1-5 are particularly useful for high-voltage rolled lithium battery modules/packs and those in Examples 6-10 for high-voltage rolled sodium battery modules/packs.

### EXAMPLE 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of LisPO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LAPON). The compound was ground in a mortar into a powder form. These ISE particles can be combined with a polymer to form hybrid solid-state electrolyte particulates for use in an anode, a cathode, and/or a separator.

### EXAMPLE 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### EXAMPLE 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under 0z atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### EXAMPLE 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5: Preparation of Halide Solid Electrolytes

As an example, the halide solid electrolytes were prepared by ball milling and subsequent solid-state reactions. Raw materials of LiCI (99.9%), InCl₃ (99.99%), ScCi₃ (99.99%,), YCl₃ (99.99%), YbCl₃ (99.99%), LuCl₃ (99.99%) and ZrCl₄ (99.9%) were used as starting materials. The stoichiometric starting materials were weighed and sealed in a ZrO₂ jar along with 18 ZrO₂ balls and the mixture was ball milled at 350 rpm for 12 hours in an Ar-filled glovebox with p(H₂O)/p<0. 1 ppm, p(O₂)/p<0.1 ppm. During ball milling, the jar was periodically opened to make the samples homogenous at each 5 h interval in a glovebox. Subsequently, the resulting mixture was sealed in quartz tubes and annealed at 260° C. for 12 h with a heating rate of 2° C. min⁻¹ and then cooled naturally to room temperature. Then, the obtained material was stored in an Ar-filled glovebox to prevent any moisture exposure.

### EXAMPLE 6: Preparation of NASICON-Type Solid-State Electrolyte, Na_{3.1}Zr_{1.95}Mg_{0.05}Si₂PO₁₂, for Sodium Batteries

The preparation of Na_{3.1}Zr_{1.95}M_{0.05}Si₂PO₁₂ (M=Mg, Ca, Sr, Ba) was conducted through a solid-state reaction combined with mechano-chemical synthesis. First, the Zr_{1.95}M_{0.05}O_{3.95} solid solutions were prepared through a mechano-chemical reaction in a high energy ball mill for 2 h. The mixture of ZrO₂ and MO was milled by alternating 30 min of milling with 30 min in a standby mode to avoid excessive heating. The solid-state electrolytes with the formula Na_{3.1}Zr_{1.95}M_{0.05}Si₂PO₁₂ (M=Mg, Ca, Sr, Ba) were synthesized through a solid-state reaction by mixing stoichiometric amounts of Na₂CO₃ (Sigma-Aldrich, purity >99.5%), SiO₂ (Sigma-Aldrich, >99%), NH₄H₂PO₄ (Sigma-Aldrich, >98%), and Zr_{1.95}M_{0.05}O_{3.95} to form a solid mixture, which was ball-milled with zirconium oxide balls for 2 h. The precursors were decomposed at 900° C. for 12 h in alumina crucibles, along with repeated ball-milling for 2 h. The calcined powders were then cold pressed and sintered at 1260° C. for 16 h in a sealed container to avoid sodium loss.

### EXAMPLE 7: Scandium-Substituted Na₃Zr₂(SiO₄)₂(PO₄) as a NASICON (Na Superionic Conductors)

NSZSP_{X} (x=0-0.6) powders can be prepared according to the below procedure: NaNO₃ (99.7% purity), Sc₂O₃ (99.5%), ZrO(NO₃)₂(Aldrich, 99%), Si(OCH₂CH₃)₄(Merck, 99%), and NH₄H₂PO₄ (Merck, 99%) were used as starting materials. Corresponding amounts of NaNO₃, Sc₂O₃, and ZrO(NO₃)₂ were first dissolved in deionized water or HNO₃ (Aldrich, ACS grade) and mixed into one solution. A stoichiometric amount of Si(OCH₂CH₃)₄ was also added to the solution while stirring. When Si(OCH₂CH₃)₄ was hydrolyzed, a proper amount of NH₄H₂PO₄ was added to the system with stirring. The homogeneous aqueous system was then transformed to a mixture of a colloidal sol and precipitates of complex zirconium-oxide-phosphate compounds.

The entire mixture was dried at 90° C. and the dried powder was calcined at 800° C. for 3 h to obtain a white powder. The morphology of the powder was investigated by scanning electron microscopy. The calcined powder was then milled in ethanol with zirconia balls on a milling machine for 48 h. The milled powder was put into a cylindrical pressing mold with diameter of 13 mm and pressed under a uniaxial pressure of 100 MPa at room temperature. The pressed pellets were then sintered at 1250-1300° C. for 5 h to obtain pure white samples. The XRD patterns of the sintered samples were recorded with a diffractometer using Cu Ka radiation. The lattice parameters and the quantitative phase analysis of the samples were determined by the Pawley and Rietveld refinement. The microstructure of the samples was also analyzed by SEM.

### EXAMPLE 8: Preparation of highly sodium ion-conducting Na₃PS₄—Na₄SiS₄ sulfide-type solid electrolytes

The (100-x)Na₃PS₄·xNa₄SiS₄ (mol %) glass-ceramics was prepared using combined mechanical milling and heat treatments. The glass-ceramics with the compositions of 0<x<10 exhibited higher conductivity than 10⁻⁴ S cm⁻¹ at room temperature. A mixture of Na₂S (purity >99.1%), P₂Sₛ(>99%; Aldrich Chemical Co. Inc.), and SiS₂ (>99.9%) powders at the composition of (100-x)Na₃PS₄₋ₓNa₄SiS₄ (mol %) was mechanically milled at ambient temperature using a planetary ball mill apparatus with a zirconia pot (45 ml) and zirconia balls (4 mm diameter). The rotation speed was 510 rpm and milling durations were 1.5-25 hours. After mechanical milling, the powdered samples were compressed with a uniaxial cold press to prepare 10 mm-diameter, 1-1.5 mm-thick pellets. To obtain the glass-ceramics, the milled sample pellets were crystallized by heating at an appropriate temperature between 220° C. and 360° C. in an electric furnace for 2 h. The heating temperature was selected based on crystallization temperatures determined using differential thermal analysis (DTA). All processes were performed in a dry Ar atmosphere. The XRD measurements of the prepared materials were performed using Cu Ka with a diffractometer. Diffraction data were collected in 0.01° steps from 10.0° to 60.0° in 2θ. DTA was performed using a thermal analyzer with a heating rate of 10° C./min.

### EXAMPLE 9: Synthesis of a Cl-Doped Tetragonal Na₃PS₄ (or t-Na₃₋ₓPS₄₋ₓClₓ) Solid Electrolyte with a Room-Temperature Na⁺ Conductivity Exceeding 1 mS Cm⁻¹(Halogen-Modified Sulfide-Type or Halide-Type of Solid Electrolyte)

Pure t-Na₃PS₄ was synthesized from reagent-grade Na₂S (99% purity) and P₂S₅(Sigma Aldrich, 99%). The precursors were mixed with a molar ratio of 75:25 and ground in agate mortar and pestle. To introduce the chloride dopant, NaCl (99.99%) was mixed into the precursors following the chemical reaction:

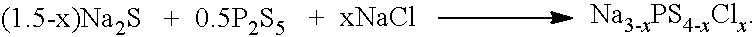

The resulting mixtures were then sealed under vacuum in a quartz tube, heated to 800° C. for 4 hours, and then quenched in ice water. Subsequently, the sample was ground in a mortar and pestle and sealed in an ampoule to be heat treated at 420° C. for 2 hours to stabilize the tetragonal phase. The samples were ground back to a powder form with mortar and pestle, and re-pelletized. These pellets were then processed under heat; e.g., via spark plasma sintering (SPS).

To prepare the sample, a 10 mm tungsten-carbide circular die was lined with graphite foil and the powder was placed in between two tungsten-carbide plungers coated with graphite. The entire setup was placed in the SPS chamber, and the sample was pressed to 100 MPa (at a pressure increment rate of 100 MPa min⁻¹), heated to 573 K (at a temperature ramping rate of 100 K min⁻¹), and then allowed to dwell under these processing conditions for 5 minutes to reach a densified state. All synthesis steps were performed in a dry, inert (Ar) atmosphere.

### EXAMPLE 10: Preparation of Complex Boron Hydride-Type Solid-State Electrolytes

Boron-enriched Na₂B₁₀H₁₀ was synthesized according to the procedure summarized as follows: the triethylammonium salt (Et₃NH)₂ [B₁₀H₁₀]was synthesized via reaction of B₁₀H₁₄ and triethylamine in para-xylene at reflux. The crude product was recrystallized from water/EtOH and dried in vacuum (10 mTorr) at room temperature for 16 h. The (Et₃NH)₂[B₁₀H₁₀]was then converted into the corresponding acid (H₃O)₂[B₁₀H₁₀]by ion exchange using an Amberlite resin in H⁺-form. Aqueous Na₂B₁₀H₁₀ was prepared by neutralization of (H₃O)₂[B₁₀H₁₀]with 0.1 M NaOH until a pH value of 7 was reached. The solvent was removed using a rotary evaporator at 53° C. Unlabeled Na₂B₁₀H₁₀ was synthesized using a similar approach. The resulting hydrated materials were dried under vacuum at 160° C. for 16 h. The solid-state electrolyte exhibits a remarkable superionic conductivity of σ≈0.01 S cm⁻¹ at 110° C.

### EXAMPLE 11: Illustrative Examples of Electronically Conductive Current Collectors

In addition to commonly used Cu foil, Al foil, and stainless steel foil, various types of metal foams and fine metal webs/screens are commercially available for use as conductive material layer for transporting electrons in an anode or cathode; e.g. Ni foam, Cu foam, Al foam, Ti foam, Ni mesh/web, stainless steel fiber mesh, etc. Metal-coated polymer foams and carbon foams are also used as current collectors. The most desirable thickness ranges for these conductive supporting porous substrate layers are 1-20 μm, preferably 5-10 μm.

### EXAMPLE 12: Lithium Metal Battery Cell and High-Voltage Modules Comprising a Lithium Iron Phosphate (LFP) Cathode and a Lithium Metal Anode

LFP powder, un-coated or carbon-coated, is commercially available from several sources. A LFP target for sputtering was prepared by compacting and sintering LFP powders together. Sputtering of LFP was conducted on a graphene film (supplied from Angstron Materials, Inc., Dayton, Ohio) and, separately, carbon nano-fiber (CNF) mat. The LFP-coated graphene film was then broken and pulverized to form LFP-coated graphene sheets. Both carbon-coated LFP powder and graphene-supported LFP, separately, along with a gel electrolyte (PEO-EC/DEC), were then cast into cathode active material layers on two surfaces of an Al foil, allowing an edge portion of the Al foil being bare (free from any other material, as illustrated in the top portion of FIG. 2(A)). A Cu foil was deposited with two layers of lithium metal to form an anode, having a bare (uncoated) 2^{nd} portion.

A cathode, a porous polymer separator, and an anode were then laminated and wound into a unit cell roll. The extended 2^{nd} portion of the Al foil (cathode) current collector (e.g., top portion of the drawings of FIG. 3(A)) was bended toward the core of the unit cell roll to form a cathode tab (e.g., top portion of the lower drawing of FIG. 3(A)). Similarly, the extended 2^{nd} portion of the Cu foil (anode) current collector (e.g., lower portions of top 2 drawings of FIG. 3(A)) was bended toward the core of the unit cell roll to form an anode tab.

Four unit cells were then internally connected in series to form a high-voltage module (slightly >12 volts) wherein the cathode tab of the first unit cell is electrically connected to an external positive terminal and the its anode tab bonded (soldered) to the cathode tab of the second unit cell. The anode tab of the second unit cell is connected to the cathode tab of third unit cell. The anode tab of the third unit cell is connected to the cathode tab of fourth unit cell. The anode tab of the fourth unit cell is electrically connected to an external negative terminal of the resulting 4-unit module.

### EXAMPLE 13: Preparation of Disodium Terephthalate (Na₂CsH₄O₄) as an Anode Active Material Of Sodium Battery Unit Cells and High-Voltage Modules

Pure disodium terephthalate was obtained by the recrystallization method. An aqueous solution was prepared via the addition of terephthalic acid to an aqueous NaOH solution and then ethanol (EtOH) was added to the mixture to precipitate disodium terephthalate in a water/EtOH mixture. Because of resonance stabilization, terephtalic acid has relatively low pKa values, which allow easy deprotonation by NaOH, affording disodium terephthalate (Na₂TP) through the acid-base chemistry. In a typical procedure, terephthalic acid (3.00 g, 18.06 mmol) was treated with sodium hydroxide (1.517 g, 37.93 mmol) in EtOH (60 mL) at room temperature. After 24 h, the suspended reaction mixture was centrifuged and the supernatant solution was decanted. The precipitate was re-dispersed in EtOH and then centrifuged again. This procedure was repeated twice to yield a white solid. The product was dried in vacuum at 150° C. for 1 h. In a separate sample, GO was added to aqueous NaOH solution (5% by wt. of GO sheets) to prepare sheets of graphene-supported disodium terephthalate under comparable reaction conditions.

Both hard carbon-disodium terephthalate mixture powder and graphene-supported disodium terephthalate, separately, were each mixed with an inorganic/polymer composite electrolyte (NASICON-type solid-state electrolyte, Na_{3.1}Zr_{1.95}Mg_{0.05}Si₂PO₁₂ dispersed in PVDF-HFP containing NaClO₄ as a sodium salt) to form layers of an anode active material deposited on primary surfaces of a graphene foam layer (AMI, Dayton, Ohio), as an anode current collector, to form an anode. A Prussian Blue cathode active layer was similarly made and bonded to the primary surfaces of an Al foil to form a cathode, wherein the cathode active layer also includes a NASICON inorganic/PVDF-HFP composite dispersed therein. An anode, a PVDF-HFP layer, and a cathode are then laminated and wound into a solid-state sodium-ion unit cell roll having a graphene sheet-based anode tab and an Al foil-based cathode tab. Three unit cells were internally connected to form a high-voltage module wherein the graphene tab of one cell and the Al foil tab of a neighboring were bonded together via a tin-based soldering material. Three high-voltage sodium-ion battery modules were then internally connected in parallel to form a high-capacity, high-voltage pack.

### EXAMPLE 14: V₂O₅ as an Example of a Transition Metal Oxide Cathode Active Material of a High-Voltage Lithium Battery Module

V₂O₅ powder alone is commercially available. For the preparation of a graphene-supported V₂O₅ powder sample, in a typical experiment, vanadium pentoxide gels were obtained by mixing V₂O₅ in a LiCl aqueous solution. The Li⁺-exchanged gels obtained by interaction with LiCl solution (the Li:V molar ratio was kept as 1:1) was mixed with a GO suspension and then placed in a Teflon-lined stainless steel 35 ml autoclave, sealed, and heated up to 180° C. for 12 h. After such a hydrothermal treatment, the green solids were collected, thoroughly washed, ultrasonicated for 2 minutes, and dried at 70° C. for 12 h followed by mixing with another 0.1% GO in water, ultrasonicating to break down nano-belt sizes, and then spray-drying at 200° C. to obtain graphene-embraced composite particulates.

Both V₂O₅ powder (with a carbon black powder as a conductive additive) and graphene-supported V₂O₅ powder, separately, along with other ingredients as in Example 13, were then made into a cathode according to the presently invented process (with the exception that the inorganic solid electrolyte used was Halogen-modified sulfide-type prepared in Example 9). Li metal foil was used as an anode layer deposited on a Cu foil. An anode, a separator layer (Halogen-modified sulfide-type inorganic/PVDF-HFP composite layers with a 32 μm thickness), and a cathode were laminated and wound to form a Li—V₂O₅ cell, having a cathode tab and an anode tab. Five Li—V₂O₅ cells were internally connected in series to form a module. The module was then housed in a pouch to form a protected pack.

### EXAMPLE 15: LiCoO₂ as an Example of Lithium Transition Metal Oxide Cathode Active Material for a Lithium-Ion Battery

Commercially available LiCoO₂ powder, carbon black powder, and PVDF resin binder were dispersed in PC-EC/LiPF₆ electrolyte to form a slurry, which was coated onto both sides of an AL foil to form a 3-layer cathode structure containing 2 cathode active material layers and a discrete electron-conducting layer. A mixture layer of 30/70 SiOₓ/graphite particles, PVDF resin binder, and an inorganic/polymer composite electrolyte (LGPS/PVDF-HFP at a 55/45 weight ratio) were coated onto both sides of a Cu foil form a 3-layer anode structure. The anode active material layer was each coated with a discrete layer of PVDF-HFP polymer electrolyte. The resulting 5-layer anode structure and the 3-layer cathode were then laminated and wound into a unit cell, each having an anode tab and a cathode tab protruded out of the cell. As an example, three unit cells were connected in series internally to form a high-voltage module or super-cell having an output voltage of 10.8 volts.

### EXAMPLE 16: Cathode Active Materials Based on Mixed Transition Metal Oxides for High-Voltage Sodium-Ion Batteries

As examples, for the synthesis of Na_{1.0}Li_{0.2}Ni_{0.25}Mn_{0.75}O, Ni_{0.25}Mn_{0.75}CO₃, or Ni_{0.25}Mn_{0.75}(OH)₂ cathode active material, Na₂CO₃, and Li₂CO₃ were used as starting compounds. Materials in appropriate mole ratios were ground together and heat-treated; first at 500° C. for 8 h in air, then finally at 800° C. for 8 h in air, and furnace cooled.

For the preparation of cathode layers using a conventional procedure, a sheet of aluminum foil was coated with N-methylpyrrolidinone (NMP) slurry of the cathode mixture. The electrode mixture is composed of 82 wt % active oxide material, 8 wt % conductive carbon black (Timcal Super-P), 2% halogen-modified sulfide-type inorganic electrolyte (prepared in Example 9) and 8 wt. % PVDF-HFP). Both Na_{1.0}Li_{0.2}Ni_{0.25}Mn_{0.75}O powder (with a carbon black powder as a conductive additive) and graphene-supported Na_{1.0}Li_{0.2}Ni_{0.25}Mn_{0.75}O powder, separately, were used. After casting, the electrode was initially dried at 70° C. for 2 h, followed by dynamic vacuum drying at 80° C. for at least 6 h.

For the anode, a sodium metal foil was cut from sodium chunks (Aldrich, 99%) that were cleaned of any oil using hexanes, then roll-pressed with a Cu foil. The cathode, a 50/50 PVDF-HFP/halogen-modified sulfide-type inorganic electrolyte layer, and an anode were then aligned, wound, and formed into a rolled unit cell. Four unit cells were internally connected in series to make a high-voltage module.

### EXAMPLE 17: Na₃V₂(PO₄)₃/C and Na₃V₂(PO₄)₃/Graphene Cathodes for High-Voltage Sodium Batteries

The Na₃V₂(PO₄)₃/C sample was synthesized by a solid state reaction according to the following procedure: a stoichiometric mixture of NaH₂PO₄·2H₂O (99.9%, Alpha) and V₂O₃ (99.9%, Alpha) powders was put in an agate jar as a precursor and then the precursor was ball-milled in a planetary ball mill at 400 rpm in a stainless steel vessel for 8 h. During ball milling, for the carbon coated sample, sugar was also added as the carbon precursor and the reductive agent, which prevents the oxidation of V³⁺. After ball milling, the mixture was pressed into a pellet and then heated at 900° C. for 24 h in Ar atmosphere. Separately, the Na₃V₂(PO₄)₃/graphene cathode was prepared in a similar manner, but with sugar replaced by graphene oxide.

Cathode was prepared by coating a cathode active layer on a porous graphene/CNT mat (as a cathode current collector). The cathode active layer was then covered by a thin layer (26 μm) of a composite electrolyte (57% of β″-Al₂O₃ particles dispersed in 43% PVDF-HFP). This composite electrolyte layer was then covered by a Na metal layer backed by a layer of porous graphene/CNT mat. The 5-layer laminate was wound to obtain a unit cell roll, each having a bare (active material-free) cathode tab and a bare anode tab. Three unit cells were then internally connected in series to form a module with an anode tab of one unit cell being bonded to a cathode tab of a neighboring cell via a CNT/epoxy adhesive.

### EXAMPLE 18: Organic Material (Li₂C₆O₆) as a Cathode Active Material of a Lithium Metal Battery

In order to synthesize dilithium rhodizonate (Li₂C₆O₆), the rhodizonic acid dihydrate (species 1 in the following scheme) was used as a precursor. A basic lithium salt, Li₂CO₃ can be used in aqueous media to neutralize both enediolic acid functions. Strictly stoichiometric quantities of both reactants, rhodizonic acid and lithium carbonate, were allowed to react for 10 hours to achieve a yield of 90%. Dilithium rhodizonate (species 2) was readily soluble even in a small amount of water, implying that water molecules are present in species 2. Water was removed in a vacuum at 180° C. for 3 hours to obtain the anhydrous version (species 3).

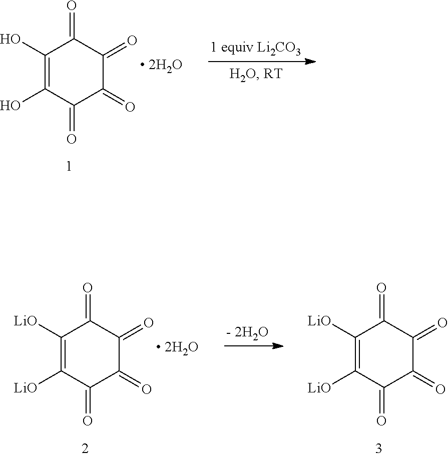

A mixture of a cathode active material (Li₂C₆O₆) and a conductive additive (carbon black, 15%) was ball-milled for 10 minutes and the resulting blend was grinded to produce composite particles. The cathode active material and conductive additive (Li₂C₆O₆/C composite particles) wetted with the quasi-solid electrolyte (2.5M of lithium hexafluorophosphate, LiPF₆, in PC-EC) were cast into discrete layers of cathode material supported by the two primary surfaces of an Al foil to form a cathode laminate.

It may be noted that the two Li atoms in the formula Li₂C₆O₆ are part of the fixed structure and they do not participate in reversible lithium ion storing and releasing. This implies that lithium ions should come from the anode side. Hence, there should be a lithium source (e.g. lithium metal or lithium metal alloy) at the anode. A primary surface of a current collector (Cu foil) was deposited with a layer of lithium to form an anode. A porous PE-PP copolymer separator layers (soaked with the quasi-solid electrolyte) was used as a separator. A cathode, a separator, and an anode layer were then laminated and wound into a unit cell roll. Five unit cells were internally connected to form a module. Three modules were internally connected to form a pack, which was wrapped around with a protective housing to produce a high-voltage battery pack.

### EXAMPLE 19: Metal Naphthalocyanine-RGO Hybrid Cathode of a Lithium Metal Battery

CuPc-coated graphene sheets were obtained by vaporizing CuPc in a chamber along with a graphene film (5 nm) prepared from spin coating of RGO-water suspension. The resulting coated film was cut and milled to produce CuPc-coated graphene sheets, which were mixed with a gel electrolyte (pentaerythritol tetra-acrylate-based polymer impregnated with LiClO₄ in propylene carbonate) and coated onto an Al foil to form a cathode. A primary surface of a current collector (Cu foil) was deposited with a layer of lithium to form an anode. A porous polymer membrane pre-soaked with a quasi-solid electrolyte containing 3.0 M of LiClO₄ in propylene carbonate (PC) solution was used as a separator. A cathode layer, a separator, and a lithium/Cu anode were then laminated and wound into a unit cell. Five unit cells were internally connected in series to form a module, which was inserted into a stainless steel can to form a high-voltage pack.

### EXAMPLE 20: Preparation of Potassium Metal Cells, Modules and Packs

The positive electrode for potassium-ion or potassium metal batteries can be selected from layered oxides (e.g., K₂CoO₂, KCrO₂, etc.), polyanion compounds (e.g., KVPO₄F, KFeSO₄F), organic compounds (e.g., poly(anthraquinonyl sulfide (abbreviated as PAQS)), polyaniline (PANI), 3,4,9,10-perylene-tetracarboxylic acid-dianhydride (commonly referred to as Pigment Red 224 (C₂₄H₈O₆) and abbreviated as PTCDA), etc.), as well as Prussian analogues (e.g., K₂MnFe(CN)₆, K₂FeFe(CN)₆, K₂NiFe(CN)₆, etc.).

As an illustrative example, particles of K₂CoO₂, reduced graphene oxide (RGO) sheets (from Angstron Materials, Inc.), and PVDF binder resin were mixed in an NMP solvent to form a slurry. The slurry was coated to the two opposing primary surfaces of a CNT mat layer to form a three layer structure, which upon removal of NMP, led to two cathode active layers bonded on the CNT mat layer. An anode comprising hard carbon particles and SBR binder were also prepared. The cathode and the anode were immersed in an electrolyte of 1 M of KClO₄ salt dissolved in a mixture of propylene carbonate and DOL (1/1 ratio) for 1 hour. A significant proportion of the solvent was removed in a vacuum oven, leaving behind a highly concentrated quasi-solid electrolyte residing in the cathode and the anode, respectively. A porous PE-PP membrane pre-soaked with a 3M potassium salt solution was used as a separator. An anode layer, a separator, and a cathode were then laminated and wound to form a unit cell. Two unit cells were internally connected in series under a protective environment to form a module, which was inserted into a stainless steel can and sealed.

1. A high-voltage alkali battery, comprising a plurality of unit cells internally connected in series to form a module or pack, wherein each unit cell comprises:
(a) a cathode comprising (i) a cathode current collector comprising a conductive material layer or foil having two opposite primary surfaces, a first and a second primary surface, wherein each primary surface has a first portion and a second portion; and (ii) a first cathode active layer bonded to the first portion, but substantially not the second portion, of the first primary surface and a second cathode active layer bonded to the first portion, but substantially not the second portion, of the second primary surface of the cathode current collector, wherein the first or the second cathode active layer comprises a mixture of a cathode active material, a binder, an electron-conducting additive, and a first electrolyte;
(b) an anode comprising (i) an anode current collector comprising a conductive material layer or foil having two opposing primary surfaces, a first and a second primary surface, wherein each primary surface has a first portion and a second portion; and (ii) a first anode active layer bonded to the first portion, but substantially not the second portion, of the first primary surface and a second anode active layer bonded to the first portion, but substantially not the second portion, of the second primary surface of the anode current collector, wherein the first or the second anode active layer comprises (ii-a) a mixture of an anode active material, a binder, an electron-conducting additive, and a second electrolyte or (ii-b) a layer of alkali metal or alkali metal alloy having higher than 60% by weight of an alkali metal selected from lithium (Li), sodium (Na), potassium (K) or a combination thereof, and
(c) a separator layer, in a form of an ion-permeable material layer or a solid-state electrolyte layer, which is disposed between the anode and the cathode and electrically separating the anode from the cathode; wherein,
the cathode, the separator, and the anode layer are laminated and wound around an axis into a roll of a unit cell having a roll height between a cathode end and an anode end, wherein the cathode end has the second portion of the cathode current collector being protruded or extended out longer than the roll height and not touching the anode current collector and wherein the anode end has the second portion of the anode current collector being protruded or extended out longer than the roll height and not touching the cathode current collector;
wherein,
the plurality of the unit cells are internally connected in such a manner that the protruded or extended out second portion of the cathode current collector of a first unit cell roll is in electronic contact with the protruded or extended out second portion of the anode current collector of a second, neighboring unit cell roll, and
wherein the first electrolyte and the second electrolyte are the same as or different from each other and all having an ion conductivity no less than 10⁻⁷ S/cm and the electrolytes are not flowable wherein the electrolyte in a unit cell is not capable of flowing to and does not flow to a neighboring unit cell.

2. The high-voltage alkali battery of claim 1, wherein the first or the second electrolyte is selected from a flexible solid polymer electrolyte, inorganic electrolyte, polymer/inorganic composite electrolyte, a quasi-solid electrolyte having an alkali salt concentration no less than 2.5 M in an organic or ionic liquid solvent, or a semi-solid electrolyte having a liquid content less than 30% by weight of the total electrolyte weight.

3. The high-voltage alkali battery of claim 1, wherein the battery further meets one or more of the following conditions: (a) the cathode comprises from 60% to 98% by weight of a cathode active material, from 1% to 15% of an electron-conducting additive, and/or from 1% to 15% of the first electrolyte selected from a solid-state inorganic, polymeric, or inorganic/polymer composite electrolyte; (b) the anode comprises from 60% to 98% by weight of an anode active material, and (c) the anode comprises from 1% to 15% of the second electrolyte selected from a solid-state inorganic, polymeric, or an inorganic/polymer composite electrolyte.

4. The high-voltage alkali battery of claim 1, wherein the first or second electrolyte comprises a flame retardant additive selected from a halogenated flame retardant, phosphorus-based flame retardant, melamine flame retardant, metal hydroxide flame retardant, silicon-based flame retardant, phosphate flame retardant, biornolecular flame retardant, or a combination thereof.

5. The high-voltage alkali battery of claim 1, wherein said cathode or anode current collector layer is selected from a metal foil, a layer of an electrically conductive polymer, a layer of carbon particles, graphite particles, carbon nanotubes, or graphene sheets in a non-woven mat form, fabric form, or dispersed in or bonded by a polymer matrix, or a combination thereof.

6. The high-voltage alkali battery of claim 1, wherein the first electrolyte or the second electrolyte comprises a polymer electrolyte selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, poly bis-methoxy ethoxyethoxide-phosphazenex, polyphosphazene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof, and wherein the polymer electrolyte comprises from 0.1% to 50% by weight of a lithium salt, a sodium salt, a potassium salt, or a combination thereof.

7. The high-voltage alkali battery of claim 1, wherein the first electrolyte or the second electrolyte comprises an inorganic electrolyte selected from β-alumina electrolyte, NASICON electrolyte, sulfide-based electrolyte, halide-based electrolyte, complex hydride electrolyte, oxide-type electrolyte, borate-type electrolyte, phosphate-type electrolyte, lithium phosphorus oxynitride (LiPON), garnet-type, lithium superionic conductor (LISICON) type, or a combination thereof.

8. The high-voltage alkali battery of claim 1, wherein the separator comprises a solid-state electrolyte, having an alkali metal ion conductivity greater than 10⁻⁶ S/cm at room temperature and is selected from a polymer electrolyte, an inorganic electrolyte, or a polymer/inorganic electrolyte.

9. The high-voltage alkali battery of claim 1, wherein said alkali battery is a lithium-ion battery, a lithium metal battery, a sodium-ion battery, a sodium metal battery, a potassium-ion battery, or a potassium metal battery, wherein the lithium metal battery is a battery that comprises lithium metal as an anode active material, the sodium metal battery is a battery that comprises sodium metal as an anode active material, and the potassium metal battery is a battery that comprises potassium metal as an anode active material.

10. A high-voltage alkali battery pack comprising multiple alkali battery modules of claim 1, each module comprising a plurality of unit cells internally connected in series and wherein the multiple alkali battery modules are internally connected in parallel to form a battery pack and the battery pack is housed in a protective casing.

11. The high-voltage alkali battery of claim 1, wherein said alkali battery is a lithium-ion battery and said anode active material is selected from the group consisting of:
(a) Particles of natural graphite, artificial graphite, meso-carbon microbeads (MCMB), needle coke, carbon particles, carbon fibers, carbon nanotubes, and carbon nano-fibers;
(b) Silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd);
(c) Alloys or intermetallic compounds of Si, Ge, Sn, Pb, Sb, Bi, Zn, Al, or Cd with other elements, wherein said alloys or compounds are stoichiometric or non-stoichiometric;
(d) Oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites;
(e) Pre-lithiated versions thereof;
(f) Pre-lithiated graphene sheets; and
combinations thereof.

12. The high-voltage alkali battery of claim 1, wherein said alkali battery is a sodium-ion battery and said anode active material contains an alkali intercalation compound selected from petroleum coke, carbon black, amorphous carbon, activated carbon, hard carbon, soft carbon, templated carbon, hollow carbon nanowires, hollow carbon sphere, titanates, NaTi₂(PO₄)₃, Na₂Ti₃O₇, Na₂CsH₄O₄, Na₂TP, NaₓTiO₂ (x=0.2 to 1.0), Na₂CsH₄O₄, carboxylate based materials, C₈H₄Na₂O₄, C₈H₆O₄, CsH₅NaO₄, C₈Na₂F₄O₄,C₁₀H₂Na₄O₈, C₁₄H₄O₆, C₁₄H₄Na₄O₈, or a combination thereof.

13. The high-voltage alkali battery of claim 1, wherein the alkali battery is a sodium-ion battery and said anode active material contains a material selected from the following groups:
(a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof;
(b) Sodium- or potassium-containing alloys or intermetallic compounds of Si, Ge, Sn, Pb, Sb, Bi, Zn, Al, Ti, Co, Ni, Mn, Cd, and their mixtures;
(c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof;
(d) Sodium or potassium salts; and
(e) Graphene sheets pre-loaded with sodium or potassium.

14. The high-voltage alkali battery of claim 1, wherein said cathode active material contains a lithium intercalation compound or lithium absorbing compound selected from the group consisting of lithium cobalt oxide, doped lithium cobalt oxide, lithium nickel oxide, doped lithium nickel oxide, lithium manganese oxide, doped lithium manganese oxide, lithium vanadium oxide, doped lithium vanadium oxide, lithium mixed-metal oxides, lithium iron phosphate, lithium vanadium phosphate, lithium manganese phosphate, lithium mixed-metal phosphates, metal fluoride, metal chloride, metal sulfide, metal selenide, elemental sulfur, elemental selenium, and combinations thereof.

15. The high-voltage alkali battery of claim 1, wherein said cathode active material contains a sodium intercalation compound or a potassium intercalation compound selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, λ-MnO₂, Na_{X}K₍₁₋ₓ₎ MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

16. The high-voltage alkali battery of claim 1, wherein said cathode active material is selected from a Na-based metal layered oxide, a K-based metal layered oxide, a polyanionic compound, a mixed polyanionic compound, a sulfate, a pyrophosphate, a Prussian Blue analog, a ferrocyanide, an organic compound, or a combination thereof.

17. The high-voltage alkali battery of claim 1, wherein said cathode active material is selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48}Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

18. The high-voltage alkali battery of claim 1, wherein said first or second electrolyte contains a lithium salt, sodium salt, or potassium salt dissolved in a liquid solvent and/or dispersed in a polymer, and wherein said liquid solvent is water, an organic solvent, an ionic liquid, or a mixture of an organic solvent and an ionic liquid.

19. The high-voltage alkali battery of claim 1, wherein said first or second electrolyte contains a solid state electrolyte or quasi-solid electrolyte having a lithium-ion or sodium-ion conductivity from 10⁻⁷ S/cm to 5×10⁻² S/cm.

20. The high-voltage alkali battery of claim 1, wherein said cathode or anode current collector contains a solid metal foil or an electrically conductive porous layer selected from metal foam, metal web or screen, perforated metal sheet-based structure, metal fiber mat, metal nanowire mat, conductive polymer nano-fiber mat, conductive polymer foam, conductive polymer-coated fiber foam, carbon foam, graphite foam, carbon aerogel, carbon xerogel, graphene foam, graphene oxide foam, reduced graphene oxide foam, carbon fiber foam, graphite fiber foam, exfoliated graphite foam, or a combination thereof.

21. The high-voltage alkali battery of claim 11, wherein said pre-lithiated graphene sheets are selected from pre-lithiated versions of pristine graphene, graphene oxide, reduced graphene oxide, graphene fluoride, graphene chloride, graphene bromide, graphene iodide, hydrogenated graphene, nitrogenated graphene, boron-doped graphene, nitrogen-doped graphene, chemically functionalized graphene, a physically or chemically activated or etched version thereof, or a combination thereof.

22. The high-voltage alkali battery of claim 1, wherein said cathode active material comprises an alkali metal intercalation compound or alkali metal-absorbing compound selected from an inorganic material, an organic or polymeric material, a metal oxide, metal phosphate, metal sulfide, metal selenide, or a combination thereof.

23. The high-voltage alkali battery of claim 22, wherein said metal oxide or metal phosphate is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, transition metal fluoride, transition metal chloride, or a combination thereof.

24. The high-voltage alkali battery of claim 22, wherein said inorganic material is selected from the following groups: (i) a transition metal dichalcogenide, a transition metal trichalcogenide, MnO₂, C₀O₂, an iron oxide, a vanadium oxide, or a combination thereof, and wherein the vanadium oxide is selected from the group consisting of VO₂, LiₓVO₂, V₂O₅, LiₓV₂O₅, V₃O₈, LiXV₃O₈, LiXV₃O₇, V₄O₉, LiₓV₄O₉, V₆O₁₃, LiₓV₆O₁₃, their doped versions, their derivatives, and combinations thereof, wherein 0.1<x<5; (ii) metal oxide/phosphate/sulfides selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals; and (iii) bismuth selenide or bismuth telluride; transition metal dichalcogenide or trichalcogenide; selenide or telluride of niobium, zirconium, molybdenum, hafnium, tantalum, tungsten, titanium, cobalt, manganese, iron, nickel, or a transition metal; boron nitride, or a combination thereof.

25. The high-voltage alkali battery of claim 22, wherein said organic material or polymeric material is selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquino-dimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PUP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

26. The high-voltage alkali battery of claim 25, wherein said thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain including conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene](PTKPTB, or poly[3,4(ethylenedithio)thiophene](PEDTT).

27. The high-voltage alkali battery of claim 22, wherein said organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

28. The high-voltage alkali battery of claim 1, wherein the plurality of the unit cells are internally connected in series in such a manner that the protruded or extended out second portion of the cathode current collector of a first unit cell roll is welded, soldered, or bonded together with the protruded or extended out second portion of the anode current collector of a second, neighboring unit cell roll.

29. A high-voltage alkali battery, comprising a plurality of unit cells internally connected in series to form a module or pack, wherein each unit cell comprises:
(a) a cathode comprising (i) a cathode current collector comprising a conductive material layer or foil having two opposite primary surfaces, a first and a second primary surface, wherein each primary surface has a first portion and a second portion; and (ii) a first cathode active layer bonded to the first portion, but substantially not the second portion, of the first primary surface, wherein the first cathode active layer comprises a mixture of a cathode active material and an electron-conducting additive;
(b) an anode comprising (i) an anode current collector comprising a conductive material layer or foil having two opposing primary surfaces, a first and a second primary surface, wherein each primary surface has a first portion and a second portion; and (ii) a first anode active layer bonded to the first portion, but substantially not the second portion, of the first primary surface and, wherein the first anode active layer comprises (ii-a) an anode active material or (ii-b) a layer of alkali metal or alkali metal alloy having higher than 60% by weight of an alkali metal selected from lithium (Li), sodium (Na), potassium (K) or a combination thereof, and
(c) a separator layer, in a form of an ion-permeable material layer or a solid-state electrolyte layer, which is disposed between the anode and the cathode and electrically separating the anode from the cathode; wherein,
the cathode, the separator, and the anode layer are laminated and wound around an axis into a roll of a unit cell having a roll height between a cathode end and an anode end, wherein the cathode end has the second portion of the cathode current collector being protruded or extended out longer than the roll height and not touching the anode current collector and wherein the anode end has the second portion of the anode current collector being protruded or extended out longer than the roll height and not touching the cathode current collector;
wherein,
the plurality of the unit cells are internally connected in such a manner that the protruded or extended out second portion of the cathode current collector of a first unit cell roll is in electronic contact with the protruded or extended out second portion of the anode current collector of a second, neighboring unit cell roll, and
wherein the first electrolyte has an ion conductivity no less than 10⁻⁷ S/cm and is not flowable wherein the electrolyte in a unit cell is not capable of flowing to and does not flow to a neighboring unit cell.

30-32. (canceled)
